(19) United States
(12) Patent Application Publication
(10) Pub. No.: US 2023/0136575 A1
(43) Pub. Date: May 4, 2023

(54) USE OF AQUEOUS DISPERSIONS OF MAGNESIUM COMPOUNDS FOR FUNCTIONAL FINISHING OF TEXTILES

(71) Applicant: BROMINE COMPOUNDS LTD., Beer-Sheva (IL)

(72) Inventors: Mohammed ABUELHAIGA, Kibbutz Mefalsim (IL); Ella RAPAPORT, Lachish Darom (IL); Itzhak SHALEV, Beit Gamliel (IL); Reuven ROZEN, Beer-Sheva (IL); Chen ZOLKOV, Kiryat Tivon (IL); Nikolay FUX, Beer-Sheva (IL); Yelena EPSHTEIN ASSOR, Beer-Sheva (IL); Gideon SHIKOLSKY, Kiryat Motzkin (IL); Orel AMAR, Ofakim (IL)

(21) Appl. No.: 17/912,642

(22) PCT Filed: Apr. 1, 2021
(86) PCT No.: PCT/IL2021/050368

§ 371 Date: Sep. 19, 2022

Related U.S. Application Data
(60) Provisional application No. 63/138,539, filed on Jan. 18, 2021.
(60) Provisional application No. 63/003,903, filed on Apr. 2, 2020.

(51) Int. Cl. D06M 11/44; D06M 11/71; B01D 46/00; B01D 39/16; A01N 59/06; A01P 1/00; A01N 25/24

(52) U.S. Cl. CPC D06M 11/44; D06M 11/71; B01D 46/0028; B01D 39/1607; A01N 59/06; A01P 1/00; A01N 25/24; D06M 2200/00; D06M 2101/06

(57) ABSTRACT

This invention provides a composition and aqueous dispersion comprising magnesium oxide, as a sole active agent or in combination with ammonium phosphate/ammonium polyphosphate for imparting anti-bacterial and/or anti-viral properties to textile products. The present invention further provides methods for preparing such compositions and aqueous dispersions and methods of using the same for textile finishing.

### FIELD OF THE INVENTION

The present invention relates to aqueous dispersions comprising magnesium compounds, particularly special grades of magnesium oxide, alone or in combination with ammonium phosphate or ammonium polyphosphate. The dispersions are provided for use in the field of functional finishing of textiles, in particular as anti-viral and anti-bacterial textile finishing agents.

### BACKGROUND OF THE INVENTION

Polymers in commercial use contain additives, to improve processability and modify the properties of the polymers. For example, textile products contain flame retardants, to increase resistance to fire, and biocides, to eliminate, or at least inhibit, deposition and growth of microorganism on or in the fabric. The additives are incorporated into a finished textile product using different techniques. For example, the additives may be formulated into a solution, emulsion or aqueous suspension and then the fabric is soaked with the solution, squeezed to remove excess liquid, and dried.

Biocides commonly used by the textile industry include organo-copper compounds, organo-tin compounds and chlorinated phenols (https://www.fibre2fashion.com/industry-article/27/biocides-in-textile). Silver-based microbial agents and metal-based inorganic compounds such as zinc oxide, zinc salts and cupric salts were also tested in fabrics, as discussed by Uddin (International Journal of Textile Science, 2014 3(1A) 15:20).

Additional examples can be found in the patent literature. CA 1,334,273 describes microbiocidal composition for use in textile, based on certain phosphate esters. A treatment of polyester fabric with an antimicrobial agent consisting of alkyl phosphate (as a quaternary ammonium salt) and diisocyanate is described in JP 10088482. Imparting antimicrobial finishing to a cotton fabric dipped in ammonium sulfate and ethoxylated alkyl amine is described in CN 105297401.

There is considerable interest in the development of textile finishes having anti-bacterial and anti-viral activity. Such finishes are particularly valuable as they can assist in preventing the spread of infectious diseases, and enable textile material to be used in hospitals without the need for frequent sterilization.

### SUMMARY OF THE INVENTION

Inorganic magnesium compounds with low solubility in water, particularly, special grades of magnesium oxide (magnesia, MgO) and/or magnesium hydroxide are available on the marketplace in different grades designed for a variety of industrial needs. Magnesium oxide is used in the plastic industry (e.g., an additive in rubbers and resins), in the pharmaceutical industry (e.g., to produce granules for production of tablets) and in the steel industry (manufacture of steel sheets for transformers).

The inventors have tested the activity of some grades of MgO in textile products and now found that MgO by itself shows bacteriostatic, antiviral and modest anti-bacterial effects in such products (e.g. polyester fabrics), and that the above action of MgO is strongly enhanced when it is supplied to the fabric in admixture with ammonium polyphosphate (APP), e.g., aluminum ammonium polyphosphate salt.

MgO and APP are both water-insoluble powders. The inventors have prepared a co-formulation, dispersing MgO and APP in water in the presence of a binder (needed to affix the active compounds to the fabric) and with the aid of customary additives (e.g., dispersants, thickeners). The MgO/APP aqueous co-formulation can be used to deliver the active components to the fabric by conventional techniques employed by the textile industry, such as padding, coating and dipping.

Accordingly, one aspect of the present invention is a composition comprising magnesium oxide, a surfactant and a thickener.

In some embodiments the magnesium oxide according to the present disclosure is characterized by having a particle size distribution with d₁₀ ranging from 0.5 to 1.5 μm, d₅₀ ranging from 1.5 μm to 6.0 μm and d₉₀ ranging from 5.0 μm to 45.0 μm, wherein said magnesium oxide is further characterized by having:
a) a surface area ranging from 5.0 to 25.0 m²/gr,
b) a Loss On Ignition (LOI) ranging from 0.2% to 8.0%,
c) a bulk density ranging from 0.25 to 0.50 gr/ml, and
d) a citric acid activity (CAA 40) ranging from 25 to 200 seconds.

In other embodiments the magnesium oxide according to the present disclosure is characterized by having a particle size distribution with d₁₀ ranging from 0.5 to 1.5 μm, by a d₅₀ ranging from 1.5 to 6.0 μm and by a d₉₀ ranging from 5.0 to 45 μm, a surface area ranging from 5.0 to 25.0 m²/gr, LOI ranging from 0.2 to 5.0%, bulk density ranging from 0.30 to 0.50 gr/ml and by citric acid activity (40) ranging from 80 to 200 seconds.

In further embodiments the magnesium oxide according to the present disclosure is characterized by having a particle size distribution with d₁₀ ranging from 0.8 to 1.5 μm, by a d₅₀ ranging from 2.5 to 6.0 μm and by a d₉₀ ranging from 10.0 to 45 μm, a surface area ranging from 5.0 to 15.0 m²/gr, LOI ranging from 2.0 to 8.0%, bulk density ranging from 0.25 to 0.35 gr/ml and by citric acid activity (40) ranging from 100 to 200 seconds.

In still further embodiments the magnesium oxide according to the present disclosure is characterized by having a particle size distribution with d₁₀ ranging from 1.0 to 1.5 μm, by a d₅₀ ranging from 2.5 to 6.0 μm and by a d₉₀ ranging from 10.0 to 45.0 μm, a surface area ranging from 5.0 to 10.0 m²/gr, LOI ranging from 0.2 to 6.0%, bulk density ranging from 0.3 to 0.5 gr/ml and by citric acid activity (40) ranging from 100 to 200 seconds.

In another aspect thereof the present disclosure provides an anti-viral and/or anti-bacterial textile finishing aqueous dispersion comprising the composition as herein defined and optionally a binder. In other words, the present disclosure provides an anti-viral and/or anti-bacterial textile finishing aqueous dispersion comprising magnesium oxide, a surfactant, a thickener and optionally a binder. The aqueous dispersion as herein defined is useful for textile finishing and for imparting anti-viral and/or anti-bacterial properties to a textile product.

In some embodiments the textile finishing aqueous dispersion according to the present disclosure comprises: from 67 to 90% by weight of water;

from 2 to 20% by weight of MgO;

from 0.5 to 4% by weight of surfactant; and

from 0.1 to 0.5% by weight of thickener.

In other embodiments the textile finishing aqueous dispersion according to the present disclosure comprises: from 67 to 90% by weight of water;

from 2 to 20% by weight of MgO;

from 0.5 to 4% by weight of surfactant;

from 0.1 to 0.5% by weight of thickener; and

from 1.5 to 15% by weight of a binder.

In further embodiments the textile finishing aqueous dispersion according to the present disclosure further comprises ammonium phosphate or ammonium polyphosphate and optionally comprises a binder.

In certain embodiments ammonium polyphosphate according to the present disclosure is aluminum ammonium polyphosphate.

In other embodiments the textile finishing aqueous dispersion according to the present disclosure comprises: from 37 to 94% by weight of water;

from 5 to 20% by weight of magnesium oxide;

from 0.5 to 4% by weight of aluminum ammonium polyphosphate;

from 0.5 to 4% by weight of a surfactant; and from 0.1 to 0.5% by weight of a thickener.

In still further embodiments the textile finishing aqueous dispersion according to the present disclosure comprises: from 37 to 94% by weight of water;

from 5 to 20% by weight of magnesium oxide;

from 0.5 to 4% by weight of aluminum ammonium polyphosphate;

from 0.5 to 4% by weight of a surfactant;

from 0.1 to 0.5% by weight of a thickener; and

from 1.5 to 15% by weight of a binder.

In some embodiments the surfactant according to the present disclosure is an anionic surfactant or nonionic surfactant. In other embodiments the thickener according to the present disclosure is a cellulose derivative or a swellable synthetic polymer. In further embodiments the binder according to the present disclosure is an acrylate, a polyurethane or a PVC binder.

In a further aspect thereof, the present disclosure provides a method of finishing or treating a textile product with an anti-viral and/or anti-bacterial aqueous dispersion as defined herein, wherein a binder is present in the dispersion.

In some embodiments, the method according to the present disclosure is imparting to the textile product virustatic or anti-viral properties. In certain embodiments, the method according to the present disclosure is imparting to the textile product virustatic or anti-viral properties against viruses of the family Coronaviridae.

In further embodiments, the method according to the present disclosure is imparting to the textile product bacteriostatic or anti-bacterial properties. In certain embodiments, the method according to the present disclosure is imparting to the textile product bacteriostatic or anti-bacterial properties against a bacteria associated with a nosocomial infection. In still further embodiments, the nosocomial infection according to the present disclosure is associated with Staphylococcus aureus or Escherichia coli or a combination thereof.

The present disclosure further provides use of magnesium oxide as at least one of a virustatic, anti-viral, bacteriostatic or anti-bacterial textile finishing agent(s).

Still further the present disclosure provides use of magnesium oxide in combination with ammonium phosphate or ammonium polyphosphate as at least one of a virustatic, anti-viral, bacteriostatic or anti-bacterial textile finishing agent(s).

By another one of its aspects the present disclosure provides a textile product coated with an anti-viral or anti-bacterial finishing comprising magnesium oxide, wherein the amount of MgO is at least 2%, e.g. up to 15% or 20%, by weight of the textile product.

Still further the present disclosure provides a textile product coated with an anti-viral or anti-bacterial finishing comprising magnesium oxide in combination with ammonium phosphate or ammonium polyphosphate, wherein the amount of MgO is at least 2%, e.g. up to 15% or 20% and the amount of ammonium phosphate or ammonium polyphosphate is at least 0.5%, e.g. up to 2% by weight of the textile product.

In some embodiments the textile product according to the present disclosure is a medical textile product, a facial mask or a fabric filter.

### BRIEF DESCRIPTION OF THE DRAWINGS

FIG. 1A-FIG. 1B: Graphs showing weight loss (%) of HA4 grade MgO samples during TGA test performed in a temperature range of up to 600° C. (FIG. 1A) or up to 900° C. (FIG. 1B).

FIG. 2A-FIG. 2B: Graphs showing viral count measured at various time points within an AATCC Test assay performed with Spunbond nonwoven 100% polypropylene 30 GSM fabrics coated with an aqueous dispersion comprising HA4 grade MgO (“MgO HA4”) or an aqueous dispersion comprising HA4 grade MgO and APP (“MgO HA4+TexFRon® AG”) and inoculated with Coliphage MS2 during the first 4 hours of the assay (FIG. 2A) or the entire assay length (FIG. 2B). “Control” relates to non-coated fabrics.

FIG. 3A-FIG. 3B: Graphs showing bacterial count measured at various time points within an AATCC Test assay performed with Spunbond nonwoven 100% polypropylene 30 GSM fabrics coated with an aqueous dispersion comprising HA4 grade MgO (“MgO HA4”) or an aqueous dispersion comprising HA4 grade MgO and APP (“MgO HA4+TexFRon® AG”) and inoculated with Staphylococcus aureus during the first 6 hours of the assay (FIG. 3A) or the entire assay length (FIG. 3B). “Control” relates to non-coated fabrics.

FIG. 4A-FIG. 4C: Graphs showing bacterial count measured at the indicated time points within an AATCC Test assay performed in the presence of Staphylococcus aureus on polyamide-lycra fabric samples coated with HA4 grade MgO aqueous dispersions comprising AC-178 (FIG. 4A), AC-2403 (FIG. 4B) or AC-75032 (FIG. 4C), subjected to 10, 20, 35 or 50 laundry cycles. “Control” relates to non-coated fabrics.

### DETAILED DESCRIPTION OF THE INVENTION

In its most general form, preparation of magnesium oxide is based on calcination of magnesium hydroxide. The temperature profile in the calcination kiln influences the properties and activity of the resultant magnesium oxide.

Magnesium oxide grades suitable for use in the invention are selected to satisfy a set of criteria, e.g.:
particle size distribution (PSD) characterized by d₁₀, d₅₀ and d₉₀ values such that d₁₀≤1.5 μm (e.g. from 0.5 to 1.5 μm, from 0.5 to 1.0 μm or from 0.8 to 1.3 μm), 1.5 μm d₅₀ 6.0 μm (e.g. from 1.5 to 5.0 μm) and 5.0 μm d₉₀ 45.0 μm, for example 8.0 μm d₉₀ 45.0 μm or 5.0 μm d₉₀ 30 μm microns (measured by laser diffraction).
specific surface area above 5.0 m²/gr, preferably from 5.0 to 25.0 m²/gr, more preferably from 5.0 to 15.0 m²/gr, more preferably from 5.0 to 10 m²/gr or from 5.0 to 9 m²/gr (measured by the BET method).
citric acid activity (CAA 40) ranging from 25 to 200 seconds, preferably from 80 to 200 seconds, e.g. from 150 to 200 seconds.
loss on ignition (LOI, a measure of residual content of magnesium hydroxide) in the range of 0.2 to 8.0% by weight, e.g., from 4.0 to 8.0%, preferably from 0.2 to 3.0% or from 0.2 to 1.0% by weight.
bulk density in the range of 0.25 to 0.50 gr/ml, for example between 0.30 and 0.40 gr/ml or from 0.25 to 0.35 gr/ml.

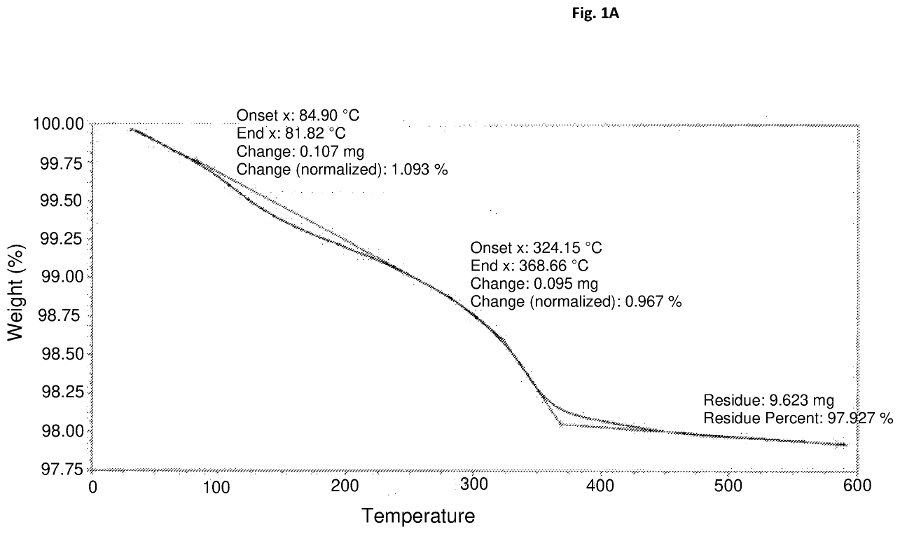

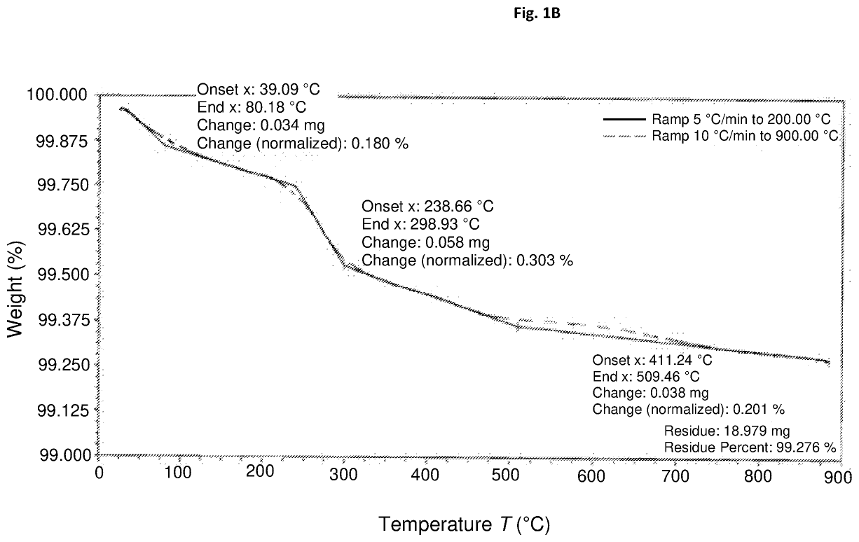

For example and as demonstrated below, magnesium hydroxide residual content (TGA) was 0.724% for a particular magnesium oxide (HA4 grade) preparation tested (TGA performed up to a temperature of 600° C.), as shown in FIG. 1A and for an additional HA4 grade magnesium oxide preparation, the magnesium hydroxide residual content (TGA) was 2.073% as shown in FIG. 1B (relating to a TGA performed up to a temperature of 900° C.)

Grades meeting the properties set for the above are available on the marketplace (e.g., MgO HA4 grade, MgO SIG-SC grade or MgO SIG-S grade from ICL-IP). An illustrative preparation of MgO for use in the invention is provided in the experimental section below, based on milling (dry milling) of MgO product obtained by calcination of magnesium hydroxide at temperature in the range of 600 to 950° C. Alternatively, preparation of MgO for use in the framework of the invention may be based on wet milling of magnesium hydroxide before the calcination step mentioned above. The magnesium hydroxide itself can be obtained either by hydrating the thermal decomposition product of magnesium chloride (the Aman process), or by precipitation reaction, i.e., between magnesium chloride and an alkaline agent such as sodium hydroxide, or calcium hydroxide or ammonium hydroxide.

The physical properties of MgO grades suitable for use in the invention can be determined based on methods well known in the art, for example as detailed in the Examples below.

In one of its aspects, the present disclosure provides an anti-bacterial and/or anti-viral textile finishing aqueous dispersion comprising magnesium oxide, a surfactant and a thickener and optionally a binder.

To prepare the composition of the invention, powders of magnesium oxide characterized as described herein, a surfactant and a thickener are mixed by any method known to a person of skill in the art. Preferred surfactants and thickeners are described below.

To prepare an aqueous dispersion of MgO, MgO powder (e.g. MgO HA4 grade from ICL-IP) is mixed with water in the presence of one or more surfactants, e.g., dispersant(s) and optionally wetting agent(s), with the aid of a dissolver stirrer/disperser operating at 300 to 600 revolutions per minute (rpm), on a laboratory scale. Then, a thickener is added. The aqueous dispersion as herein defined may further comprise a binder, e.g., an acrylic binder, which is added last to the dispersion.

A stable dispersion of MgO in water is formed, with MgO content of not less than 2%, e.g., from 2 to 20% by weight based on the total weight of MgO dispersion. When present, the concentration of the binder is usually from 1.5 to 15%. The concentration of the surfactant(s) (e.g. dispersant(s)) is from 0.5 to 4%. The concentration of the thickener is from 0.1 to 0.5%. When added, the concentration of the wetting agent(s) is from 0 to 0.4% (up to 0.4%). The MgO dispersion may optionally further comprise a softener and additional textile additives as known in the art.

Accordingly, preferred MgO aqueous dispersions of the invention comprise (percentage by weight based on the total weight of the MgO aqueous dispersion):

from 67 to 90% by weight of water, e.g., 70 to 80%;

from 2 to 20% by weight of MgO; e.g., from 9.9 to 13.4%;

from 0.5 to 4% by weight of surfactant (e.g. dispersant), e.g., 0.9 to 1.5%;

from 0.1 to 0.5% by weight of thickener, e.g., from 0.3 to 0.5%; and

from 1.5 to 15% by weight of binder, e.g., 9 to 15%.

It should be understood that the term “aqueous dispersion” (used interchangeably with “aqueous suspension”) for the purpose of the present disclosure means the dispersion of solids (powders) and additives described herein in an aqueous carrier. The aqueous dispersion is usually characterized by a concentration of solids ranging from 20% by weight to 40% by weight of the total weight of the aqueous dispersion/suspension. The solid content includes all the components of the dispersion except for the aqueous carrier, such as the MgO powder, the APP powder (namely ammonium phosphate or ammonium polyphosphate, when present), a binder, a surfactant (e.g. dispersant), etc.

As detailed herein the action of MgO was found by the inventors to be strongly enhanced when supplied to the fabric in admixture with ammonium polyphosphate (APP), e.g., aluminum ammonium polyphosphate salt. Without wishing to be bound by theory, the enhanced anti-bacterial and anti-viral properties result (among others) from a uniform textile coverage provided by addition of APP to the aqueous dispersion as herein defined.

Therefore, the present invention further provides an anti-bacterial and/or anti-viral textile finishing aqueous dispersion as described herein, further comprising ammonium phosphate or ammonium polyphosphate.

The ammonium phosphate or ammonium polyphosphate suitable for use in accordance with the present invention is preferably a multivalent metal complex of ammonium polyphosphate as described in WO 2016/199145, in particular in reference to U.S. Pat. No. 8,524,125, i.e., the reaction product of a condensed form of phosphoric acid (super phosphoric acid); a source of multivalent metal (e.g., aluminum compound such as Al(OH)₃); and ammonium hydroxide, which can be recovered as a white, free-flowing fine powder, namely, aluminum ammonium polyphosphate or aluminum ammonium superphosphate, in an amorphous form, with high phosphorus content of above 60% by weight, e.g., of 70% to 80% by weight, measured as PO₄³⁻; nitrogen content of above 8% by weight, e.g., of 9 to 10% by weight, measured as NH₄⁺; Al content of above 5% by weight, e.g., of 6 to 8% by weight; and water content of ˜5 to 10% by weight. A suitable commercially available product is TexFRon® AG from ICL-IP at a particle size distribution of d₅₀<5 microns, d₉<15 microns and d₉₉<35 microns. The notation APP is used herein to indicate any ammonium phosphate/polyphosphate, including the multivalent metal complexes exemplified and/or set forth above. Further phosphate agents suitable for use in accordance with the present invention, in cases where multiple laundering cycles are not necessary, are, among others, mono ammonium phosphate (MAP) or sodium pyrophosphate decahydrate (NAPP).

In specific embodiments the MgO/APP co-dispersion as herein defined comprises MgO and ammonium phosphate/ammonium polyphosphate which is TexFRon® AG (aluminum ammonium polyphosphate).

MgO/APP co-formulation (interchangeably referred to as co-dispersion) according to the present disclosure may be prepared by first separately formulating or dispersing each one of MgO and APP as described above. The resulting individual MgO and APP dispersions are then combined to give an MgO/APP co-formulation, i.e. in a dispersion form. The weight ratio MgO:APP in the co-formulation is, for example, in the range of 5:1 up to 20:1, e.g. 10:1, 15:1 etc.

MgO/APP co-formulation according to the present disclosure is alternatively prepared by co-suspending both water-insoluble solids in a single dispersion. Specifically, MgO powder (e.g. MgO HA4 grade from ICL-IP) is mixed with water in the presence of one or more surfactants, e.g., dispersant(s) and optionally wetting agent(s), with the aid of a dissolver stirrer/disperser operating at 300 to 600 revolutions per minute (rpm), on a laboratory scale. APP (e.g. TexFRon® AG from ICL-IP) is successively and gradually added, while stirring continues. The last added components are the (optional) binder, e.g., an acrylic binder, a thickener and optionally a softener.

A stable dispersion/suspension of both MgO and APP in water is formed, with MgO content of not less than 5%, e.g., from 5 to 20% by weight based on the total weight of MgO/APP dispersion and with APP content of not less than 0.5%, e.g., from 0.5 to 4% by weight based on the total weight of MgO/APP dispersion. The concentration of the binder is from 1.5 to 15%. The concentration of the surfactant (e.g. dispersant(s)) is from 0.5 to 4%. The concentration of the thickener is from 0.1 to 0.5%. When added, the concentration of the wetting agent(s) is from 0.1 to 0.5% and the MgO/APP dispersion may optionally further comprise a softener and additional textile additives, as known in the art.

Accordingly, the present invention further provides an aqueous dispersion comprising:

from 37 to 94% by weight of water;

from 5 to 20% by weight of magnesium oxide;

from 0.5 to 4% by weight of ammonium phosphate/ammonium polyphosphate;

from 0.5 to 4% by weight of a surfactant;

from 0.1 to 0.5% by weight of a thickener; and from 1.5 to 15% by weight of a binder.

Preferred aqueous dispersions of the invention comprise (percentage by weight based on the total weight of the MgO/APP aqueous dispersion):

from 37 to 94% by weight of water, e.g., 75 to 90%;

from 5 to 20% by weight of MgO; e.g., from 9.9 to 13%;

from 0.5 to 4% by weight of aluminum ammonium polyphosphate, e.g., 0.9 to 2%;

from 0.5 to 4% by weight of dispersant, e.g., 2 to 4%;

from 0.1 to 0.5% by weight of thickener, e.g., from 0.2 to 0.3% and

from 1.5 to 15% by weight of binder, e.g., 5 to 10%.

As known to any person skilled in the art, the amount of binder is varied according to the desired application. For example, when washing durability is required higher amounts of binder will be used, as compared to when fabric flexibility is required, lower amounts of binder will be used.

A binder is required to affix the MgO alone or in admixture with APP to the fabric and is therefore part of the aqueous dispersion of the present disclosure (though it may be added just prior to application of the dispersion to the fabric). Representative examples of binders that are suitable for use on textiles are described in WO 2016/199145 and include, without limitation, acrylates, polyurethanes, and PVC binders. Preferably, the binder used in the dispersion described herein is an acrylate. The acrylic monomers structural units of the acrylate resin can be selected from alkyl acrylate and alkyl methacrylate (alkyl esters of acrylic acids or methacrylic acid), where the alkyl group is preferably Cl-05 alkyl, e.g., methyl, ethyl, propyl (e.g., n-propyl) and butyl (e.g., n-butyl). The parent acid -acrylic acid or methacrylic acid -may also be used in small amounts to provide the resin. The acrylic monomers may be optionally functionalized. Additional examples include 2-phenoxyethylacrylate, propoxylated 2 neopentyl glycol diacrylate, polyethylene glycol diacrylate, pentaerythritol triacrylate, 2-(2-ethoxyethoxy) ethyl acrylate. Commercial acrylate resins (e.g. AC-170, AC-178, AC-2403, AC-75032, etc.) which contain from 47 to 90% solids.

The MgO or MgO/APP suspension/dispersions described herein further contain customary additives. Major types of additives include:

one or more surfactants, i.e., dispersants, emulsifiers, wetting agents, dispersants/wetting agent combinations (usually from 0.5 to 4% by weight each, e.g. 1.5 to 2.5% by weight each);

one or more softeners (usually from 2 to 5% by weight each, e.g., from 2 to 3% each) one or more rheology modifiers, i.e., thickeners (usually from 0.1 to 0.5% by weight each, e.g., from 0.2 to 0.5% each).

Dispersant(s), wetting agent(s) or dispersing agent(s) possessing the necessary wetting properties are present in each of the individual MgO or MgO/APP suspensions described herein, i.e., at a concentration from 0.5 to 4.0% (e.g. 1.5 to 2.5%) by weight each, based on the total weight of the individual suspension. The dispersants may be oligomers, polymers or alkoxylates, as described in WO 2016/199145. For example, to prepare the MgO and MgO/APP suspension(s), a polymeric anionic surfactant (e.g., TERSPERSE® 2735 from Huntsman), sodium polymethacrylate (e.g., or Darvan®-7N from Vanderbilt Minerals, LLC) or anionic surfactants based on salts of sulfonic acids (e.g., alkyl aryl sulfonates, such as sodium di-isopropyl naphthalene sulfonate) may be used, at 2 to 4% by weight based on the total weight of the MgO or MgO/APP aqueous dispersion. Polymeric dispersants can be used, e.g., nonionic acrylate copolymer (such as DYSPERBYK®-2010, available in an emulsion form).

Rheology additives, e.g., thickening and anti-settling agent, for example, water soluble nonionic polymers such as the commonly used hydroxyethyl cellulose (HEC) thickener, are usually added at a concentration of 0.1 to 0.5% by weight based on the total weight of the MgO or MgO/APP aqueous dispersion in each of the individual suspension/dispersions.

For example, to prepare the MgO and/or MgO/APP suspension(s) as herein described, the thickening agent Cellosizem QP 100MH (Hydroxyethyl cellulose, high molecular weight HEC, 1% Brookfield viscosity of 4400-6000 cp; particle size # mesh of at least 98%) at 0.1-0.5% by weight based on the total weight of the MgO or MgO/APP aqueous dispersion was used.

One or more softening agents (such as ethers and polyglycol esters, ethoxylated products, paraffins, fats or fatty acid condensates) may further be added to the suspension(s) of the present disclosure at the final stage of preparation thereof, at a concentration in the range of 2 to 5% by weight based on the total weight of the MgO or MgO/APP aqueous dispersion in each one of the individual suspensions.

Further textile additives which may be used for preparing the dispersion(s) of the present invention include but are not limited to an antifoaming agent, a preservative, a dye, a pigment and any mixture thereof.

As detailed herein the present invention further provides a method of finishing or treating a textile product with an anti-bacterial and/or anti-viral aqueous dispersion as herein defined, namely comprising magnesium oxide, a surfactant, a thickener, a binder and optionally ammonium phosphate/ammonium polyphosphate.

Specifically, the present invention relates to a method comprising finishing or treating a textile product with any one of the aqueous dispersion(s) described and defined herein. The method of the invention is for imparting to the textile product at least one of virustatic, anti-viral, bacteriostatic or anti-bacterial properties.

Textile can be made bacteriostatic, virustatic, anti-bacterial and/or anti-viral by treating or coating thereof with the dispersions as described herein, in any industrially acceptable manner, such as padding (a wet finishing process comprising impregnation of the fabric with a formulation/dispersion and subsequently squeezing the fabric between heavy rollers to remove any excess formulation), coating, spraying (or otherwise applying the aqueous dispersions as defined herein onto the textile or fabric). Dip-coated fabrics are generally cured for 3 to 6 minutes at about 120 to 160° C. (a thermal process with the purpose of evaporating the solvent and promoting any chemical reactions necessary to fix the finish on the textile/fabric). Other types of fabrics and techniques of treating them with aqueous dispersions as defined herein are described in WO 2016/199145.

The application of the aqueous dispersion(s) as defined herein to the textile can be affected for example either during the dying or the finishing stage of the textile by the manufacturer thereof or at a later stage (e.g. after finalizing the preparation of the textile product). Application of the aqueous dispersion(s) as defined herein to the textile can be repeated.

As exemplified below, the aqueous dispersion(s) of the present invention is/are added to the textile product or fabric in an amount effective to reduce the growth of microorganisms or at least arrest or inhibit growth thereof. The resulting textile product includes additives collectively referred to by the term “add-on”. By the term “add-on” level (or percentage) it is meant the total amount of additives (including non-active) loaded onto the treated textile product or fabric; it is calculated based on the difference between the weight of the fabric before and after the treatment/curing (i.e., dried fabric). Adequate bacteriostatic or anti-bacterial, virustatic or anti-viral properties, namely prevention of microorganism growth or reduction of 1-3 orders of magnitude in microorganism culture, respectively as described in the experimental section below, is achieved with the aid of the MgO or MgO/APP aqueous suspension/dispersions as herein defined, at “add-on” levels of 2 to 20% by fabric weight.

Therefore by a further aspect thereof the present invention provides a textile product treated or coated with an anti-viral or anti-bacterial finishing (aqueous dispersion) comprising magnesium oxide, a surfactant, a binder, a thickener and optionally ammonium phosphate/ammonium polyphosphate, in which the amount of MgO is at least 2%, e.g. up to 15% or 20%, and the amount of APP when present is at least 0.5%, e.g. up to 2% by weight of the textile product. The amount of the total dry weight added by the dispersion as herein defined to the fabric is 2 to 20%.

Experimental work conducted in support of this invention demonstrates that an MgO suspension prepared as detailed herein displays a bacteriostatic effect and a mild anti-bacterial effect when padded onto different types of fabric samples, as evident from the reduction of about one order of magnitude in bacterial count after up to 24 hours compared to time zero.

In fabrics treated with a dispersion prepared as detailed herein comprising a combination of MgO (HA4 grade) and APP (TexFRon® AG), a strong anti-bacterial effect was displayed, as the bacterial count decreased by about three (3) orders of magnitude after 24 hours, compared to time zero (e.g. as demonstrated in Example 1).

In addition, the inventors have demonstrated in Example 2 the anti-viral properties of suspensions prepared and applied to fabrics as detailed herein, which contain either MgO alone or MgO in admixture with APP. The anti-viral properties were demonstrated by a reduction in viral count of about three (3) orders of magnitude after 24 hours, compared to time zero, upon application of the above suspensions.

Therefore by another one of its aspects the present disclosure provides for use of magnesium oxide as at least one of a virustatic, anti-viral, bacteriostatic or anti-bacterial textile finishing agent(s).

By a further aspect, the present disclosure provides for use of magnesium oxide in combination with ammonium phosphate or ammonium polyphosphate as at least one of a virustatic, anti-viral, bacteriostatic or anti-bacterial textile finishing agent(s).

In particular, the present invention relates to magnesium oxide and optionally ammonium phosphate or ammonium polyphosphate (or textile finishing aqueous dispersion comprising the same) for use as anti-viral textile finishing agent(s) and to the use of magnesium oxide and optionally ammonium phosphate or ammonium polyphosphate (or textile finishing aqueous dispersion comprising the same) as anti-bacterial textile finishing agent(s).

In other words, the present invention provides a method for preventing or reducing bacterial or viral growth on a textile product (or part thereof), said method comprising finishing or treating said textile product with an anti-viral and/or anti-bacterial aqueous dispersion comprising magnesium oxide, a surfactant, a thickener, a binder and optionally ammonium phosphate or ammonium polyphosphate.

Thus the present invention further provides a method for imparting to a textile product virustatic or anti-viral, bacteriostatic or anti-bacterial properties, said method comprising finishing or treating said textile product with an aqueous dispersion comprising magnesium oxide, a surfactant, a thickener, a binder and optionally ammonium phosphate or ammonium polyphosphate.

As shown in the examples that follow, anti-bacterial and anti-viral effects were demonstrated for textiles treated by aqueous dispersion(s) comprising MgO alone or in admixture with APP, where the textiles were challenged (or inoculated) with Staphylococcus aureus, Coliphage MS2 and E. coli.

Microbial growth as known in the art is effected by a microorganism or a combination thereof. The present disclosure relates to any microorganism, including but not limited to viruses (e.g. viruses of the family Coronaviridae) and bacteria (e.g. Escherichia coli or bacteria associated with nosocomial infections, such as but not limited to Staphylococcus aureus (e.g. Methicillin-resistant Staphylococcus aureus) and Pseudomonas aeruginosa). The present invention may contribute to inhibition of growth of additional microorganisms, such as archaea, algae, fungi (e.g. yeasts and molds), protozoa, and a combination thereof.

By the term “reducing microbial growth” as used herein it is referred to slowing the reproduction rate, or stopping the reproduction, or eliminating the living microbial cells as compared to a non-treated textile object, e.g. by about 1, 10, 15, 20, 30, 40, 50% or more to 100%.

The anti-bacterial and/or anti-viral (as well as the virustatic or bacteriostatic) properties of the aqueous dispersions of the present disclosure may be determined by any method known in the art, for example by performing the AATCC 100 test method for textile testing. The AATCC 100 test method evaluates the antibacterial properties of textiles over a 24-hour period of contact (which may be extended), quantitatively assessing biostatic (growth inhibition) or biocidal (killing of microorganisms) properties. The test method consists of preparation of samples, sterilization, inoculation, incubation, washing/shaking out, and counting.

The textile finishing as herein defined relates to imparting anti-viral and/or anti-bacterial properties to textile, including virustatic and bacteriostatic properties, respectively. The term “biocide” as known in the art refers to a substance that kills microorganisms and their spores. Depending on the type of microorganism affected, a biocidal agent may be further defined as a bactericide (or an anti-bacterial agent), fungicide (anti-fungal agent), as an anti-viral agent, algaecide, etc. The general term “biostatic” refers to a substance that prevents the growth (multiplication) of the microorganism and its spores, and encompasses bacteriostatic (referring to bacteria), virustatic (referring to viruses), fungistatic and algae-static substances.

As shown in the examples below, the aqueous dispersion(s) of the present invention comprising MgO alone or a combination of MgO and APP (MgO/APP) are applicable on a large variety of textiles (fabric or cloth), woven/knit or non-woven (e.g. for the manufacture of filters, for example air conditioning filters) which is natural, synthetic or blends thereof, for example, composed of fibers selected from wool, silk, cotton, nylon, polypropylene, linen, hemp, ramie, jute, acetate, lyocell, acrylic, polyolefin, polyamide, polylactic acid, polyester, rayon, viscose, spandex (also known as elastane, e.g. polyamide-lycra), metallic composite, ceramic, glass, carbon or carbonized composite, and any combination thereof. Exemplary textiles are woven 12% nylon 66 88% cotton 170 gram per square meter (GSM), spunbond nonwoven 100% polypropylene 30 GSM, 20 GSM and lycra.

The textile product as herein defined is therefore made of a woven/knit or a non-woven fabric. The amount (percentage) of MgO and when present, the amount (percentage) of APP by weight in the fabric is determined based on considerations known to a person of skill in the art, based on the fabric type.

The dispersion(s) as herein defined is/are applicable to any textile product, including but not limited to a medical textile (e.g. a protective medical facial mask, a medical filter, a medical bandage, a medical dressing, etc.), an article of clothing (e.g. a facial mask), a fabric filter (e.g. for production of air-conditioning filters), a garment, a diaper, a linen, a decorative textile, a technical textile, a drapery, a carpet, a tent, a sleeping bag, a toy, a wall fabric, a mattress or an upholstery.

On a daily basis, many healthcare professionals are exposed to bacteria on their clothing. Furthermore, the covid-19 coronavirus pandemic, among others, urged the use of disposable facial protective masks, which may be replaced, entirely or partially, by washable textile product facial masks.

Therefore the present aqueous dispersion(s) as herein defined are particularly applicable to medical textiles, for example facial masks.

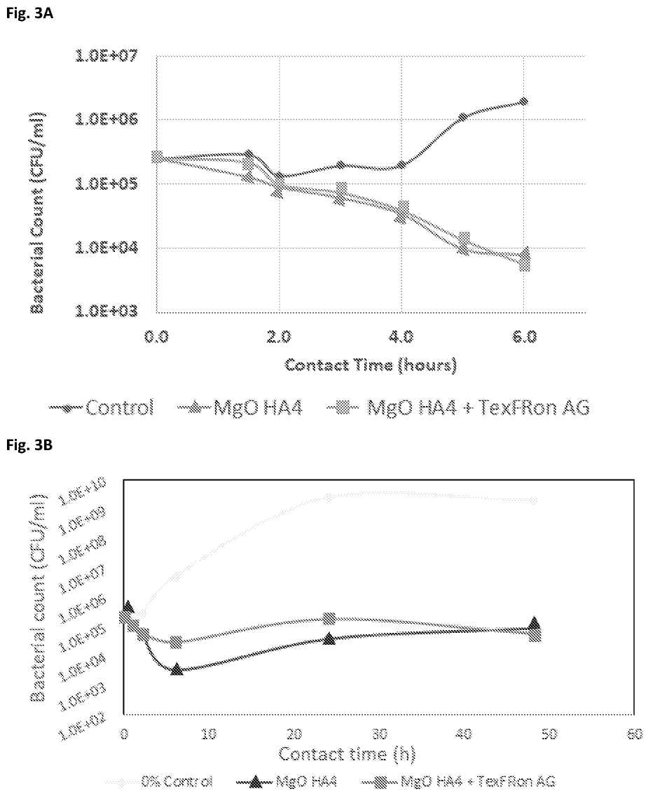

As further shown in the appended examples, a pronounced anti-bacterial effect was exerted by the aqueous dispersion(s) comprising either MgO alone or a combination of MgO and APP during the first 6 hours of the test (FIG. 3A). Then, a slow increase in the bacterial count was observed (FIG. 3B), albeit to a significantly lower extent than the increase in bacterial count observed in the control measurement, demonstrating an overall bacteriostatic effect. Importantly, the observed bacteriostatic effect was steady during the remaining timeframe of the assay, namely for up to 48 hours.

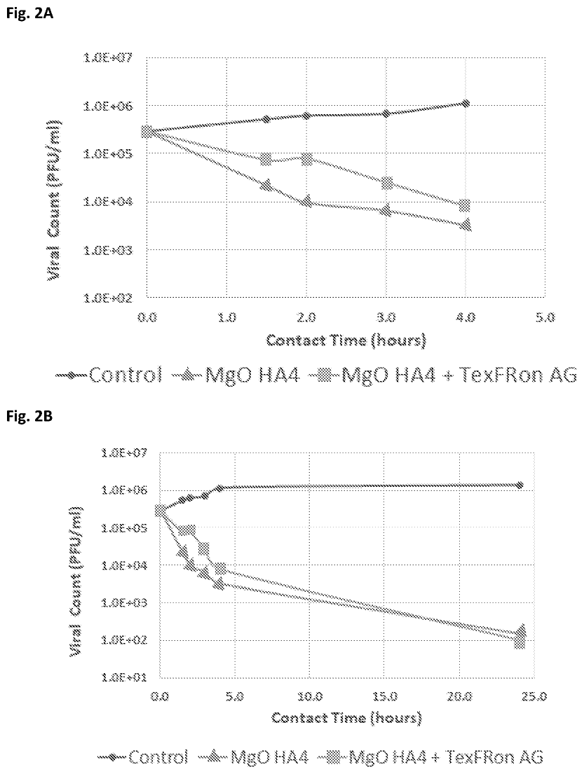

A similar effect was observed when the textile was inoculated with Coliphage MS2, where a pronounced anti-viral effect was demonstrated for the aqueous dispersion(s) comprising either MgO alone or a combination of MgO and APP during the first 4 hours of the test (FIG. 2A). In this case, however, a steady further decrease in viral count (anti-viral effect) was observable throughout the entire timeframe of the assay, for up to 24 hours.

The above results demonstrate the durability of the textile coated with the aqueous dispersion(s) as herein defined comprising either MgO alone or in combination with APP, which withstand multiple washing cycles, enabling the use of a bacteriostatic/virustatic and/or anti-bacterial/anti-viral textile product for periods of time of 2 to 24 hours before subjecting the textile product to washing or sterilization.

The invention will be further described and illustrated by the following examples.

### EXAMPLES

Materials

Materials used for preparing the formulations (aqueous dispersions) in the Examples below are tabulated in Table 1 (FR is the abbreviation of flame retardant):

TABLE 1
Materials

| Component | | |
|---|---|---|
| (manufacturer) | GENERAL DESCRIPTION | FUNCTION |
| MgO (ICL-IP) | Magnesium oxide, various | active agent |
| | grades | |
| TexFRon ® AG | Aluminum ammonium | phosphorus |
| (ICL-IP) | polyphosphate | FR (APP) |
| Disperbyk ®-2010 | Aqueous emulsion of a | dispersing |
| (BYK-Chemie | structured acrylate | and wetting |
| GmbH) | copolymer with pigment- | agent |
| | affinic groups | |
| Tersperse ®-2735 | Polymeric anionic | dispersing |
| (Huntsman) | surfactant | agent |
| Darvan ®-7N | Sodium polymethacrylate and | dispersing |
| (Vanderbilt | water | agent |
| Minerals) | | |
| Supragil ® WP | sodium di-isopropyl | wetting |
| (Rhodia) | naphthalene sulfonate. | agent |
| AC 178 | Acrylic based copolymer | binder |
| (B.G POLYMER) | dispersion | |
| AC 2403 | Acrylic based copolymer | binder |
| (ALBERDINGK) | dispersion | |
| AC 75032 | Acrylic based copolymer | binder |
| (ALBERDINGK) | dispersion | |
| AC 170 (B.G | Acrylic based copolymer | binder |
| POLYMER) | dispersion | |
| Cellosize ™ QP | Hydroxyethyl cellulose | thickener |
| 100MH (Dow) | (high molecular weight HEC, | |
| | 1% Brookfield viscosity of | |
| | 500-1500 cp; particle size | |
| | # mesh of at least 98%) | |
| Wacker ® CT 78 E | nonionic macro | softener |
| (Wacker) | emulsion of a reactive, | |
| | aminofunctional silicone | |
| | fluid | |
| Mg(OH)₂, FR-S-10 | Magnesium Hydroxide, | active agent |
| grade (ICL-IP) | FR-S-10 grade | |

Methods

Fabric coating (application): fabrics were treated by padding with the formulations (interchangeably referred to as “aqueous dispersions”). Padding was applied by using a padder (Rapid HORIZONTAL PADDING MANGLE-Air-Pad) for impregnating both sides of the fabric, by placing the formulation between the two rolls of the padder and passing the fabric between the two rolls such that the formulation is adsorbed into the fabric, and by squeezing the fabric to the desired moisture content by adjusting the pressure on the rollers. Alternatively, the fabric was coated by knife over roll back-coating only one side of the fabric. Coated fabrics were cured at 160° C. for 4 minutes, laundered 10 times or alternatively, once, 20, 35 or 50 times, as indicated below, according to AATCC Standard Practice for Home Laundry at 60° C., bone dried and tested according to AATCC Test Method 100-2019: “Antibacterial Finishes on Textile Materials” as detailed below.

AATCC Test Method 100-2019: The AATCC 100 method is the textile industry's standard for antimicrobial fabric performance in the USA and consists of six key steps: preparation of fabric samples (for example as detailed above), sterilization (for example by autoclave, at 1.2 atmospheres, at a temperature of 121° C., for 20 minutes), inoculation by applying a microorganism suspension, for example of 1 ml at 1×10⁵ CFU/ml on the fabric, incubation at 37° C. for the required incubation period (for example between about 20 minutes and about 48 hours), washing/shaking out, for example by applying neutralization buffer on the fabric sample and collecting the culture with the neutralization buffer, and counting (the colonies formed). Organisms are incubated in favorable conditions to provide a clear indication of the antimicrobial properties of the test fabric.

Specifically, the test was performed as follows: samples were prepared by padding the fabrics with the formulations (aqueous dispersions) as detailed above and cutting the fabric into circles of 4.8 cm. Fabric samples were then sterilized by autoclave, and then inoculated with 1 ml suspensions of the microorganism tested (e.g. Coliphage MS2 also termed Escherichia virus MS2 (ATCC 15597), Staphylococcus aureus (ATCC 6538) and E. coli (ATCC 8739) at 1×10⁵ CFU/ml for the bacteria and at 1×10⁵ PFU/ml for the virus. The samples were then incubated at 37° C. for different incubation (contact) times. At zero time and at various other time points (e.g. after 20 minutes, 1.5, 2, 3, 4, 5 or 24 hours) fabric samples were washed by a neutralizing solution (20 ml of a universal neutralizer, prepared by mixing 3 g lecithin, 30 g Tween® 80, 7.84 g Na2S203*5H₂O, 1 g histidine, 30 g saponin, 1 g Tryptone and 8.5 g NaCl in 1 liter distilled water). The extracted microorganism cultures were inoculated according to a method suitable to the microorganism concerned, specifically at 37° C. for up to 48 hours.

Measurement of the average secondary particle size of magnesium oxide particles: Measurement of the average secondary particle size of MgO was conducted as follows. About 0.15 grams of a sample was put in a dry 50 ml beaker, about 20 ml of isopropanol as a dispersion medium was added, the mixture was stirred using a magnetic stirrer for about 10-15 seconds and then dispersed in an ultrasonic homogenizer (Elmasonic P) for three (3) minutes and the particle size distribution was measured by a laser diffraction scattering type particle size distribution measuring apparatus (Malvern Mastersizer 2000).

Citric acid activity (CAA 40): CAA 40 was measured as the time (seconds) for reacting 40% of the weighed product with the equivalent volume of citric acid. To this end, 100 ml of 0.4 N citric acid with phenolphthalein was adjusted to 30° C. Magnesium oxide particles (2 gr samples) were added to the resulting solution and the solution was stirred with a magnetic stirrer. The time (seconds) measured from adding the magnesium oxide powder to the solution up until the color of the tested solution changed from colorless to pink was determined as a CAA value in seconds.

Measurement of the surface area: Surface area analysis was measured according to the BET method (based on a method by Brunauer, Emmett and Teller) with Quantachrome NOVA e2000 instrument, using a multipoint BET method.

Apparent density measurement: Apparent density was measured by gently introducing the sample into a 250 ml receiver until the 250 ml mark was reached. The weight of the contents of the receiver was measured. Apparent density (g/ml)=mass of the sample in the receiver (gr): volume of receiver (250 ml).

LOI (loss on ignition): LOI test was conducted as follows.

A weighted sample was calcined at 1000° C. for 15 minutes. After cooling of the sample in a desiccator, the sample was weighed again. LOI was calculated by the following formula: [(initial sample weight -sample weight after calcination)/initial sample weight]×100%.

TGA (thermal gravimetric analysis): TGA, a method in which the mass of a sample is measured over time as temperature changes, was performed using a TA discovery TGA 5500 instrument with a 10 mg sample of the tested product, which was heated in a disposable aluminum crucible from room temperature up to 600° C. or 900° C. depending on the expected maximum thermal stability of the tested compound at 10° C./min under air or nitrogen environment.

Preparation 1 Preparation of Magnesium Oxide of Various Grades

A) Preparation of Magnesium Oxide SIG/HA4 Grade

Magnesium chloride (MgCl₂) solution at a concentration of 400-550 gr/l was roasted at a high temperature in a reactor (700-850° C.). Magnesium chloride was thereby decomposed to magnesium oxide (MgO) and hydrochloric acid (HCl). Magnesium oxide (MgO) was hydrated to magnesium hydroxide (Mg(OH)₂) at a temperature of 60-90° C. Magnesium hydroxide was washed from soluble salts and milled to the required particle size, and then fed to a high temperature (600 to 950° C.) kiln where magnesium hydroxide was decomposed to magnesium oxide and water. This MgO grade was named “SIG” (the term “SIG” refers to magnesium oxide derived from magnesium hydroxide, characterized by a very low LOI, reflecting almost no hydroxide in the powder). The kiln is built of several floors, where temperature in each floor is separately controlled, and the product (powder) is moved from one floor to another by rabble arms. The rotation speed of the rabble arm determines the residence time in each floor under the specific temperature of the floor. The analytical results of a SIG grade MgO sample are provided in Table 2 below.

TABLE 2
Analytical results of MgO SIG grade sample

| | | | | Typical |
|---|---|---|---|---|
| Test | Units | Specification | | result |
| Assay as Magnesium | % | 96-100.5 | | 99.7 |
| oxide, MgO | | | | |
| Chlorides as Cl | ppm | 1000 | | 712 |
| Boron as B₂O₃ | ppm | 200 | max | 122 |
| Alumina as Al₂O₃ | ppm | 500 | max | 59 |
| Silica as SiO₂ | ppm | 500 | max | 73 |
| Sodium as Na | ppm | 200 | max | 172 |
| Surface Area S.A. | m²/gr | 5 | min | 7.0 |
| Sulphates as SO₄ | % | 0.4 | max | 0.09 |
| Calcium as CaO | % | 0.5 | max | 0.12 |
| Iron as Fe₂O₃ | ppm | 700 | max | 56 |
| Loss on Ignition | % | 3.0 | max | 0.2 |
| Bulk Density (untapped) | g/cc | 0.25 | min | 0.46 |
| Particle Size: residue | % | 25 | max | 5.4 |
| on 325 mesh (wet sieve) | | | | |
| Particle Size: residue | % | 5.0 | max | 0.3 |
| on 100 mesh (wet sieve) | | | | |

B) Preparation of Magnesium Oxide HA4 Grade

The SIG grade obtained according to the process described above was milled in a dry milling system (Jet Mill or pin mill) operated within the range of between 2 and 4.5 atmospheres of dry air pressure and powder flow rate between 100 to 200 kg/hr. The milling machine “Jet Mill” was kept under slightly negative pressure (very close to zero pressure) in order to control particle size distribution, Loss on ignition (LOI) and surface area. This grade was named HA4. Analytical results obtained for HA4 grade MgO sample are provided in Table 3 below.

TABLE 3
Analytical results of MgO HA4 grade sample

| | | | | Typical |
|---|---|---|---|---|
| Test | Units | Specification | | result |
| Assay as Magnesium | % | 96-100.5 | | 99.7 |
| oxide, MgO | | | | |
| Free Alkali | ml | 2.0 | max | 0.54 |
| Acid insoluble HAc | % | 0.1 | max | 0.038 |
| Soluble Salts/ | mg | 2.0 | max | 1.5 |
| Substances | | | | |
| Chlorides as Cl | % | 0.1 | max | 376 |
| Arsenic as As ICP | ppm | 1.5 | max | 0.6 |
| Calcium as CaO | % | 1.0 | max | 0.06 |
| Iron as Fe | ppm | 700 | max | 37 |
| Loss on Ignition | % | 4.0 | max | 0.6 |
| Lead as Pb ICP | ppm | 0.5 | max | 0.4 |
| Bulk Density (untapped) | g/cc | 0.25 | min | 0.32 |
| Particle Size: residue | % | 1.0 | max | 0.1 |
| on 325 mesh (wet sieve) | | | | |

| | | | |
|---|---|---|---|
| Particle Size: residue | % | 0 | 0 |
| on 100 mesh (wet sieve) | | | |

MgO HA4 grade is characterized by a d₁₀ lower than 1.5 microns (namely 10% of the particles are smaller than this size), by a d₅₀ ranging from 1.5 to 6.0 microns (namely 50% of the particles are smaller than this size), by a d₉₀ ranging from 8.0 to 45 microns (namely 90% of the particles are smaller than this size), by specific BET surface area above 5.0 m²/gr, by a citric acid activity (40) ranging from 25 to 200 seconds, by a Loss on Ignition (LOI) ranging from 0.2 to 4.0%, and by a bulk density (untapped) of not less than 0.25 gr/ml.

Analytical results obtained for HA4 grade MgO samples (tested by TGA) are shown in FIGS. 1A and 1n FIG. 1B. FIG. 1A spans a temperature change of up to 600° C. and demonstrates that the sample weight was maintained at 99.276%, which means that the magnesium hydroxide residual content was 0.724%. FIG. 1B spans a temperature change of up to 900° C. and shows a sample weight of 97.927%, which means that the magnesium hydroxide residual content was 2.073%.

C) Preparation of Magnesium Oxide SIG-S Grade

The MgO SIG grade obtained according to the process of Example 1(A) was treated with steam. The resulting product was termed “SIG-S” grade.

D) Preparation of Magnesium Oxide SIG-SC Grade

The MgO SIG grade obtained according to the process of Example 1(A) was treated with steam and with carbon dioxide. The resulting product was termed “SIG-SC” grade.

Based on analytical characterization, the SIG-SC grade samples are characterized by a d₁₀ ranging from 0.8 to 1.5 microns, by a d₅₀ ranging from 2.6 to 6.0 microns, by a d₉₀ ranging from 10.0 to 45 microns, by a surface area ranging from 5.0 to 15.0 m²/gr, by a citric acid activity (40) ranging from 100 to 200 seconds, by a Loss on Ignition (LOI) ranging from 2.0 to 8.0%, and by a bulk density (10 Taps) ranging from 0.25 to 0.35 gr/ml.

Table 4 shows some of the properties of the various grades of MgO prepared according to Example 1 (A-D).

TABLE 4
Properties of MgO samples

| | CAA | SA | d₅₀ | d₉₀ | <1 μm |
|---|---|---|---|---|---|
| MgO grade | (sec) | (m²/gr) | (μm) | (μm) | (%) |
| SIG | 167 | 7.2 | 4.22 | 22.25 | 7.5 |
| HA4 | 109 | 8.8 | 2.03 | 10.65 | 13.8 |
| SIG SC (not milled) | 157 | 8.9 | 5.0 | 28.4 | 6.1 |
| SIG SC (milled) | 136 | 8.8 | 2.04 | 5.94 | 15.9 |

CAA, citric acid activity; SA, surface area.

E) Preparation of Additional Magnesium Oxide Grades

Additional grades of Magnesium Oxide were prepared, by varying the kiln properties, such as time, temperature etc., to modify the particle size distribution, surface area and reactivity of the magnesia particles. Additional examples of MgO grades tested were E-10A and RA-40 (Periclase Minerals), characterized as having from 2-12% magnesium hydroxide and/or magnesium carbonate. Characterization of E-10A and RA-40 MgO grades is presented in Table 5 below.

Physical properties of SIG grade MgO prepared as described above and commercially available E-10A and RA-40 MgO are presented in Table 5 below. Magnesium hydroxide samples are provided as reference.

TABLE 5
Size distribution and surface area
of MgO and Mg(OH)₂ compounds

| | | d₁₀ | d₅₀ | d₉₀ | d₉₉ | BET |
|---|---|---|---|---|---|---|
| Type | Product | (μm) | (μm) | (μm) | (μm) | (m²/gr) |
| MgO | SIG | 1.49 | 4.74 | 29.77 | 64.1 | 8.6 |
| MgO | E-10A | 1.13 | 2.45 | 5.95 | 12.07 | 172 |
| MgO | RA-40 | 1.3 | 3.39 | 11.47 | 37.04 | 60 |
| Mg(OH)₂ | HD-5 | 1.5 | 4.76 | 15.68 | 60.45 | 2.3 |
| Mg(OH)₂ | S-10 | 0.86 | 1.4 | 2.99 | 4.56 | 9 |
| Mg(OH)₂ | HD-12 | 1.83 | 10.92 | 32.63 | 97.85 | 1.6 |

Preparation 2

Aqueous Dispersion of Magnesium Oxide

Aqueous dispersions of magnesium oxide were prepared using any of the MgO grades prepared as described above (or commercially available) according to the following procedure. First, water was added. Then the liquid dispersant (for example TERSPERSE 2735) was added to the water and stirred. The MgO powder of the desired grade was gradually added while stirring and stirring was continued for 30 minutes (Dissolver IKA, 300-600 rpm). Then, acrylic binder was added and finally, a thickener (for example HEC QP-100MH) was added as required for viscosity modification.

The compositions of two exemplary HA4-grade MgO aqueous suspensions prepared following the above procedure, one for use with knit/woven fabric and the other for use with non-woven fabric, are tabulated below in Tables 6 and 7, respectively.

TABLE 6
MgO dispersion for coating knit/woven fabric

| | Amount | % by |
|---|---|---|
| Component | (g) | weight |
| Liquid dispersant for water dispersible | 5.28 | 1.5 |
| granules, TERSPERSE 2735, Huntsman | | |
| water | 250 | 70 |
| MgO at alternative grades (e.g. HA4, SIG, | 48 | 13.4 |
| SIG-S, SIG-SC) | | |
| Acrylic Binder (e.g. AC-178 [BG | 54.4 | 15 |
| Polymers], AC2403 or AC75023 | | |
| [ALBERDINGK]) | | |
| Thickener, Cellosize TM, QP-100 HEC QP | 1 | 0.28 |
| 100MH, Dow | | |

TABLE 7
MgO dispersion for coating light, non-woven fabric

| | Amount | % by |
|---|---|---|
| Component | (g) | weight |
| Liquid dispersant for water dispersible | 13.2 | 1.3 |
| granules, TERSPERSE 2735, Huntsman | | |
| water | 956 | 82.2 |
| MgO at alternative grades (e.g. HA4, SIG, | 120 | 10.3 |
| SIG-S, SIG-SC) | | |
| Acrylic Binder (e.g. AC-178 [BG | 68 | 5.9 |
| Polymers], AC2403 or AC75023 | | |
| [ALBERDINGK]) | | |
| Thickener, Cellosize TM, QP-100 HEC QP | 3.6 | 0.3 |
| 100MH, Dow | | |

When a softener was added, it was at a final concentration of 2% by weight).

Preparation of aqueous dispersions comprising the various grades of MgO (e.g. SIG grade, E-10A and RA-40) was according to the above procedure, with specific amounts of the components for example as detailed in Table 6 above or as indicated in the Examples which follow.

The water content in the dispersion was varied according to absorbing capacity of the fabric type and the desired final add on percentage in the fabric (between about 2% to 20%). It is noteworthy that diluted formulations are suitable for coating absorptive fabrics, while concentrated formulations are suitable for coating non-absorptive fabric.

Preparation 3

Aqueous Dispersion of Aluminum Ammonium Polyphosphate (APP)

Aluminum ammonium polyphosphate (also termed herein aluminum ammonium superphosphate or TexFRon® AG, 300 g) was added to a vessel which was previously charged with water (484.5 g), a dispersing agent (Disperbyk® 2010, 12 g) and a wetting agent (Supragil® WP, 1.2 g) under stirring at a rate of 300 to 600 RPM (using IKA dissolver). The dispersion was kept under stirring for fifteen minutes and then an acrylic binder (AC-178, 150 g) was added. Lastly, a thickener (hydroxyethyl cellulose, Cellosize HEC QP-100MH, 0.57 g) was added. Stirring was continued for an additional 30 minutes. The concentration of aluminum ammonium superphosphate in the dispersion was 31.6% by weight. The composition is tabulated below in Table 8.

TABLE 8
Aqueous dispersion of aluminum ammonium
superphosphate containing 40% solids

| | Amount | % by |
|---|---|---|
| Component | (g) | weight |
| Water | 484.5 | 51.1 |
| Liquid dispersant for water dispersible | 12 | 1.3 |
| granules, TERSPERSE 2735, Huntsman | | |
| Wetting agent | 1.2 | 0.1 |
| TexFRon ® AG | 300 | 31.7 |
| Binder AC178 | 150 | 15.8 |
| Thickener (Cellosize TM, QP-100 HEC QP | 0.57 | 0.1 |
| 100MH, Dow) | | |

Preparation 4

Aqueous Dispersion of MgO/APP

Formulations comprising both MgO powder and TexFRon® AG were prepared as detailed below. First, water was added. Then the liquid dispersant (TERSPERSE 2735, 5.28 g) was added to the water and stirred at a rate of 300 rpm (using IKA® DISSOLVER). MgO powder (48 g) was gradually added while stirring and stirring was continued for 30 minutes. Then, TexFRon® AG dispersion was added (40 g dispersion of 40% solids-containing dispersion prepared as described in Table 8 above). Next, an acrylic binder was added (AC-178, 54.4 g) was added. Finally, a thickener (HEC QP-100MH, 1 g) was added. The amounts of each component are detailed in Table 9 below:

TABLE 9
MgO HA4 grade and TexFRon ® AG suspension

| | Amount | % by |
|---|---|---|
| Component | (g) | weight |
| Liquid dispersant TERSPERSE 2735, | 5.28 | 1 |
| Huntsman | | |
| Water | 400 | 73 |
| MgO HA4 grade | 48 | 8.7 |
| TexFRon ® AG (base dispersion containing | 40 | 7.2 |
| 40% solids) | | |
| Acrylic Binder, AC-178 [BG Polymers] | 54.4 | 9.9 |
| Thickener- Cellosize TM, QP-100 HEC QP | 1 | 0.2 |
| 100MH, Dow | | |

The amount of binder was varied according to the desired application. For example, when washing durability is required, higher amounts of binder are used, as compared to when fabric flexibility is required, then lower amounts of binder are used.

Preparation 5

Aqueous Dispersion of Mg(OH)₂ (S-10 Grade)

As a reference, dispersions of Mg(OH)₂ (S-10 grade) in water were also prepared by the addition of acrylic binder, surfactant, and a polymeric thickener to the Mg(OH)₂ slurry, as detailed below.

First, solid Mg(OH)₂ (60 g, ICL-IP FR-S-10) was dispersed in deionized water (219 g) with a dispersion agent (Tersperse 2735, Huntsman) (6.6 g), 50% Acrylic Binder (AC-178, B.G. polymer) (15 g) and Hydroxyethylcellulose (HEC) QP-100MH (Dow) (1 gr). This dispersion was used on 50% polyester/cotton fabrics.

Alternatively, the solid Mg(OH)₂ (60 g) was dispersed in deionized water (478 g) with a surfactant, such as TERSPERSE 2735 (6.6 g), 50% Acrylic Binder (such as AC-170, B.G. Polymer) (34 g) and thickener (such as HEC, 2 g). This dispersion was padded onto 100% cotton textiles.

The compositions of two dispersions prepared as described above (for coating 50% and 100% cotton fabrics) are described in Table 10.

TABLE 10
Mg(OH)₂ textile dispersions

| | Dispersion | Dispersion |
|---|---|---|
| | For 100% | For 50-50% |
| | cotton | Cotton/polyester |
| Component | fabric | fabric |
| Dry solids (wt %) | 14.7 | 24.9 |
| Mg(OH)₂ (wt %) | 10.33 | 19.9 |
| Dispersion agent | 1.13 | 2.2 |
| Acrylic binder | 2.92 | 2.5 |
| Thickener | 0.34 | 0.33 |
| Water | 85.3 | 75.1 |

### Example 1

Antibacterial Properties of Fabrics Coated with MgO HA4 Alone or in Combination with TexFRon® AG

The goal of the study reported in this Example was to evaluate the anti-bacterial effect of applying to fabrics a dispersion comprising MgO HA4 grade alone, alongside evaluating the anti-bacterial effect of a dispersion comprising MgO HA4 grade in combination with APP (TexFRon®AG).

To this end, woven 12% nylon 66, 88% cotton 170 GSM fabric samples were separately padded as detailed above, with each one of the following dispersions (which were prepared as detailed above): a dispersion containing HA4 grade MgO (Preparation 1), a dispersion containing TexFRon® AG (Preparation 2) or with a dispersion containing both agents (Preparation 3).

The samples are labeled 1A, 2A and 3A, respectively, in Table 11 below, to refer to the first experiment performed. Additional experiments are labeled by “B”, “C”, etc.

The fabrics were then subjected to the AATCC Test Method 100-2019 as described above. Briefly, the fabrics were cut into circles of 4.8 cm which were sterilized by autoclave. The fabric circles were then inoculated with 1 ml of suspended bacteria (Staphylococcus aureus and E. coli). At zero time and after 24 hours, the circles were washed by a neutralizing solution (20 ml of the universal neutralizer detailed above) and the bacteria extracted thereby were inoculated by the pour plate method, using agar nutrient medium. The inoculated petri dishes were incubated at 37° C. for 48 hours.

Tables 11 and 12 below show the results of two experiments conducted as described above, on two different fabric types, respectively: woven 12% nylon 66, 88% cotton 170 GSM (gram per square meter) and pocketing woven 12% nylon 66, 88% cotton 170 GSM.

TABLE 11
Anti-bacterial effect against S. aureus and E. coli

| | | | | Bacterial | Bacterial |
|---|---|---|---|---|---|
| | | | | Count, | Count, |
| | | | | At time | After |
| | % Add- | | | zero | 24 hrs |
| Sample | on* | % MgO** | Treatment | CFU/ml | CFU/ml |
| CONTROL | 0 | 0 | no treatment | 2.38E+05 | 2.55E+09 |
| 1A | 16.8 | 10 | MgO | 2.48E+05 | 2.48E+05 |
| 2A | 22 | 0 | APP | 2.45E+05 | 1.57E+06 |
| 3A | 21.6 | 11 | MgO/APP | 1.65E+05 | 1.00E+02 |

*% Add-on relates to the weight percentage of solids (MgO, APP or their combination along with all additives, e.g. a binder) included in the dispersion of total fabric weight.
**% MgO relates to the weight percentage of MgO of the total fabric weight.

As can be seen from Table 11, bacterial count increased by four (4) orders of magnitudes on the fabric that was not treated (control).

The magnesia had a bacteriostatic effect on fabric sample 1A treated by HA4 grade MgO, displaying no change in the bacterial count after 24 hours, compared to time zero. Fabric sample 2A treated by TexFRon® AG, displayed similar bacteriostatic effect.

However, on fabric sample 3A, treated by a combination of HA4 grade MgO and TexFRon® AG, a strong anti-bacterial effect was displayed, as the bacterial count decreased by about three (3) orders of magnitude after 24 hours, compared to time zero.

Additional test results obtained by coating pocketing woven 12% nylon 66, 88% cotton 170 GSM with HA4 grade MgO alone (sample labeled 1B) or in combination with TexFRon® AG (sample labeled 3B) and inoculating the fabric with bacteria, are shown in Table 12 below.

TABLE 12
Anti-bacterial effect against S. aureus and E. coli

| | | | | Bacterial | Bacterial |
|---|---|---|---|---|---|
| | | | | Count, | Count, |
| | | | | At time | After |
| | % Add- | | | zero | 24 hrs |
| Sample | on* | % MgO | Treatment | CFU/ml | CFU/ml |
| CONTROL | 0 | 0 | No treatment | 1.85E+06 | 5.50E+10 |
| CONTROL | 0 | 0 | No treatment | 2.45E+06 | 5.20E+10 |
| 1B | 12.3 | 7.6 | MgO | 2.35E+06 | 2.15E+05 |
| 3B | 11.6 | 5.9 | MgO/APP | 2.45E+06 | 1.00E+03 |

*% Add-on relates to the weight percentage of solids (MgO, APP or their combination along with all additives, e.g. a binder) included in the dispersion of total fabric weight.
**% MgO relates to the weight percentage of MgO of total fabric weight.

As demonstrated in Table 12, on fabric samples that were not treated (two control samples), bacterial count increased by about four (4) orders of magnitudes.

On the fabric sample labeled 1B, treated by HA4 grade MgO (at 7.6%), magnesia had a strong bacteriostatic effect and a minor anti-bacterial effect, displaying about one order of magnitude reduction in bacterial count after 24 hours, compared to time zero.

However, on the fabric sample labeled 3B, treated with a combination of HA4 grade MgO (at 5.9%) and TexFRon® AG (at 1.5%), a strong anti-bacterial effect was displayed, as the bacterial count decreased by about three (3) orders of magnitude after 24 hours, compared to time zero.

The above results suggest that fabric coating with a dispersion comprising a combination of HA4 grade MgO and TexFRon® AG provides an anti-bacterial effect.

### Example 2

Antiviral Properties of Fabrics Coated with HA4-Grade MgO Alone or in Combination with TexFRon® AG

The goal of the study reported in this Example was to evaluate the antiviral effect of applying on fabrics a dispersion comprising MgO HA4 grade, either alone or in combination with TexFRon® AG.

To this end, Spunbond nonwoven 100% polypropylene 30 GSM fabrics were coated with a dispersion comprising HA4-grade MgO alone (Preparation 1) or with a dispersion comprising a combination of HA4-grade MgO and TexFRon® AG (Preparation 3). The fabrics were then subjected to the AATCC Test Method 100-2019.

Briefly, the fabrics were cut into circles of 4.8 cm and were sterilized by autoclave. The fabric circles were inoculated with 1 ml of suspended Coliphage MS2 (ATCC 15597). At zero time and after 1.5, 2, 3, 4 and 24 hours, the circles were washed by a neutralizing solution (20 ml of the universal neutralizer detailed above) and the extracted coliphage were inoculated according to the double layer method (Standard Methods for the Examination of Water and Wastewater. 22-nd Edition. American Public Health Association, American Water Works Association, Water Environment Federation, Sections: SM 9224C).

Table 13 below shows the results obtained for the above experiment. Samples treated with MgO and with MgO/APP dispersions are labeled 1C and 3C, respectively.

TABLE 13
Anti-viral effect against Coliphage MS2

| | % | | Viral count (after different contact times), PFU/ml | | | | | |
|---|---|---|---|---|---|---|---|---|
| Sample | MgO | Treat. | 0 | 1.5 hr | 2 hr | 3 hr | 4 hr | 24 hr |
| Cont. | 0 | Cont. | 2.98E+05 | 5.30E+05 | 6.28E+05 | 6.90E+05 | 1.15E+06 | 1.38E+06 |
| 1C | 8.66 | MgO | —* | 2.23E+04 | 9.73E+03 | 6.58E+03 | 3.25E+03 | 1.50E+02 |
| 3C | 7 | MgO/APP | —* | 7.50E+04 | 7.95E+04 | 2.48E+04 | 7.88E+03 | 1.00E+02 |

*Viral counts are similar to the viral count obtained for the control measurement at time zero.
% MgO relates to the weight percentage of MgO of total fabric weight. Abbreviations: Treat., treatment; Cont., control; hr, hour.

As demonstrated in Table 13 above, viral count remained approximately at the same level throughout the experiment on the fabric sample that was not treated (control), as expected.

On the fabric sample labeled 1C treated by MgO (at 8.66%), a strong anti-viral effect was observed, displaying about three (3) orders of magnitude reduction in viral count after 24 hours, compared to time zero. As can be appreciated from Table 13, the decrease in viral count over the measurement time was gradual, with a clear anti-viral effect even after 24 hours of incubation.

A similar anti-viral effect was shown for the fabric sample labeled 3C, treated by a combination of HA4 grade MgO (at 7%) and TexFRon® AG (at 0.7%).

The above results suggest that fabric coating with a dispersion comprising HA4 grade MgO or a combination of HA4 grade MgO and TexFRon® AG also provide an anti-viral effect.

The anti-viral activity presented in Table 13 above is also graphically presented in FIG. 2A, showing results obtained during the first four hours of the experiment and in FIG. 2B, showing the results obtained throughout the 24 hours of the experiment.

As shown in FIG. 2A, coating of fabric with a dispersion comprising MgO alone was slightly more efficient than using a dispersion comprising both agents, during the first four hours of the experiment. However, over time (i.e. the 24 hour experiment, FIG. 2B), the dispersion comprising MgO alone and the dispersion comprising both MgO and TexFRon® AG showed comparable anti-viral activities.

### Example 3

Duration of the Anti-Bacterial Effect of Fabrics Coated with HA4-Grade MgO Alone or in Combination with TexFRon® AG

Next, the anti-bacterial effect of fabrics coated with HA4-grade MgO in the absence and in the presence of TexFRon® AG was studied during a prolonged duration of up to 48 hours.

To this end, spunbond nonwoven 100% polypropylene 30 GSM was paddded by dispersion(s) as detailed above. Briefly, as detailed in Table 14 below, fabric was coated with a dispersion containing HA4-grade MgO alone (Preparation 1), with a dispersion containing HA4-grade MgO alone in the presence of softener (Preparation 1S) or with a dispersion containing both HA4-grade MgO and TexFRon® AG (Preparation 3).

A softener is required in the dispersion at higher add on levels. The following assay tests, among others, whether addition of a softener to the dispersion has any effect on the anti-bacterial activity of the dispersion.

The fabrics were tested based on standard AATCC Test Method 100-2019 as detailed above. Briefly, the coated fabrics were cut into circles of 4.8 cm, sterilized by autoclave and the circles were then inoculated with 1 ml of suspended bacteria (Staphylococcus aureus, ATCC 6538). At zero time and after 15 minutes, 60 minutes, 2, 6, 24 and 48 hours, the circles were washed by a neutralizing solution (20 ml) and the extracted bacteria were inoculated on nutrient agar for 48 hours, at 37° C. The results are shown in Table 14 below.

TABLE 14
Duration of the anti-bacterial effect against Staphylococcus aureus over time

| Sam. | % | | Bacterial count (after different contact times) CFU/ml | | | | | | |
|---|---|---|---|---|---|---|---|---|---|
| No. | MgO | Treat. | 0 | 15 min | 60 min | 2 hr | 6 hr | 24 hr | 48 hr |
| Cont. | 0 | Cont. | 3.1E+05 | 2.3E+05 | 3.6E+05 | 2.9E+05 | 5.6E+06 | 2.6E+09 | 2.0E+09 |
| 1D | 8.66 | MgO HA4 | 2.3E+05 | 3.5E+05 | 1.3E+05 | 7.2E+04 | 3.6E+03 | 4.1E+04 | 9.5E+04 |
| 1SD | 5.63 | MgO HA4 | 1.8E+05 | 2.2E+05 | 1.8E+05 | 6.0E+04 | 3.7E+04 | 1.5E+05 | 3.2E+04 |
| | | with soften. | | | | | | | |
| 3D | 7 | MgO HA4 + | 2.2E+05 | 2.2E+05 | 1.3E+05 | 6.8E+04 | 3.0E+04 | 2.0E+05 | 6.1E+04 |
| | | TexFR | | | | | | | |

% MgO relates to the weight percentage of MgO of total fabric weight. Abbreviations: Treat., treatment; soften., softener; TexFR, TexFRon ® AG; Sam. No., sample No.; Cont., control.

As shown in Table 14, bacterial count increased un-interruptedly on the fabric sample that was not treated (control), by about four (4) orders of magnitude during the 48 hours of the experiment.

Coating the fabric with a dispersion containing HA4-grade MgO (sample 1D), a dispersion containing HA4-grade MgO and a softener (sample 1SD) or with a dispersion containing both HA4-grade MgO and TexFRon® AG (sample 3D) resulted in a strong bacteriostatic effect observed during the entire time frame tested, namely for up to 48 hours.

Notably, a moderate anti-bacterial effect was observed for all of the tested fabrics (namely for samples 1D, 1SD, and 3D) after six hours, with reductions of one to two orders of magnitude in bacterial count as compared to time zero. The reduction in bacterial count after six hours for the above samples is also graphically presented in FIG. 3A, where only the control sample and samples 1D and 3D are shown.

As detailed above, a softener is required at higher Add-on levels. The results presented above show that addition of a softener does not impair the anti-bacterial activity of the dispersion.

Furthermore, as shown in Table 14 and as graphically presented in FIG. 3B, bacterial count slightly increased after six hours in the tested coated fabrics. However, after 48 hours, a clear reduction in bacterial count as compared to the control sample was observed (of 4-5 orders of magnitude), suggesting that the bacteriostatic effect was stable throughout the time frame tested.

The above example shows that fabric coated as detailed above shows strong anti-bacterial properties for up to 6 hours and may be thus used during at least 6 hours before being washed or sterilized.

### Example 4

The Effect of Multiple Laundry Cycles on the Anti-Bacterial Activity of MgO Dispersions on Fabric

The effect of multiple washing cycles was further examined on fabrics coated with HA4 grade MgO dispersions. To this end, three different HA4-grade MgO aqueous dispersions were prepared, according to the method described above, each comprising a different binder, namely, AC-178, AC-2403 or AC-75032. The composition of the aqueous dispersions prepared are detailed in Table 6 above.

The above dispersions were (separately) padded, as detailed above, on polyamide-lycra samples. After coating with various MgO dispersions, the fabric samples were cured at 160° C. for 4 minutes, and laundered 10, 20, 35 or 50 times, dried and tested according to the AATCC Test Method 100-2019, as described above.

Briefly, the fabrics were cut into circles of 4.8 cm, sterilized by autoclave and inoculated with 1 ml of suspended bacteria (Staphylococcus aureus, ATCC 6538). At zero time and after 2, 5 and 24 hours, the circles were washed by a neutralizing solution (20 ml) and the extracted bacteria were inoculated on nutrient agar for 48 hours, at 37° C. Table 15 below shows the results of the above experiment.

TABLE 15
Anti-bacterial effect of HA4 grade MgO coated fabric
against S. aureus after multiple washing cycles

| Sam. | % | | Bacterial count (after different contact times) CFU/ml | | | |
|---|---|---|---|---|---|---|
| No. | MgO | Treat. | 0* | 2 hr | 5 hr | 24 hr |
| Cont. | — | Cont. | 1.93E+05 | 2.43E+05 | 6.28E+07 | 2.12E+09 |
| 1G-10 | 7.47 | AC-178 | — | 3.35E+04 | 2.80E+03 | 3.13E+05 |
| | | 10 cycles | | | | |
| 1G-20 | 7.47 | AC-178 | — | 1.20E+04 | 1.13E+03 | 6.68E+06 |
| | | 20 cycles | | | | |
| 1G-35 | 7.47 | AC-178 | — | 3.04E+04 | 1.32E+04 | 2.03E+03 |
| | | 35 cycles | | | | |
| 1G-50 | 7.47 | AC-178 | — | 2.78E+04 | 7.70E+03 | 6.40E+05 |
| | | 50 cycles | | | | |
| 1H-10 | 9.96 | AC-2403 | — | 3.03E+04 | 1.45E+03 | 6.92E+04 |
| | | 10 cycles | | | | |
| 1H-20 | 9.96 | AC-2403 | — | 5.83E+04 | 2.78E+03 | 3.70E+03 |
| | | 20 cycles | | | | |
| 1H-35 | 9.96 | AC-2403 | — | 2.70E+04 | 9.88E+03 | 2.45E+04 |
| | | 35 cycles | | | | |
| 1H-50 | 9.96 | AC-2403 | — | 5.33E+04 | 2.60E+04 | 1.96E+06 |
| | | 50 cycles | | | | |
| 1I-10 | 9.3 | AC-75032 | — | 3.70E+04 | 2.35E+03 | 7.04E+06 |
| | | 10 cycles | | | | |
| 1I-20 | 9.3 | AC-75032 | — | 3.25E+04 | 2.75E+02 | 2.70E+06 |
| | | 20 cycles | | | | |
| 1I-35 | 9.3 | AC-75032 | — | 2.95E+04 | 1.08E+03 | 6.50E+06 |
| | | 35 cycles | | | | |
| 1I-50 | 9.3 | AC-75032 | — | 3.30E+04 | 1.34E+04 | 3.94E+05 |
| | | 50 cycles | | | | |

*Bacterial counts at time zero are similar to the bacterial count obtained for the control measurement at time zero.
% MgO relates to the weight percentage of MgO out of the total fabric weight. Abbreviations: Treat., treatment; Sam. No., Sample number; Cont., control; cycles, laundry cycles.

As shown in Table 15 above and similar to the observations in previous examples, in the absence of MgO coating, an increase in bacterial count was observed (specifically, an increase of 4 orders of magnitudes).

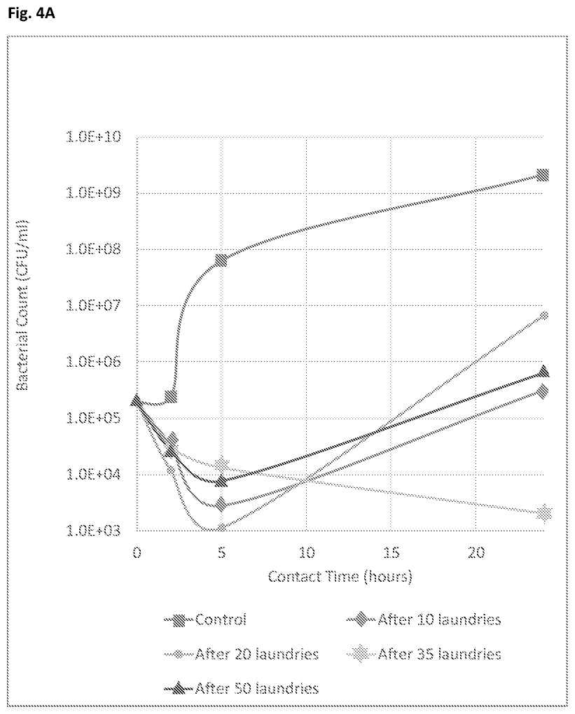

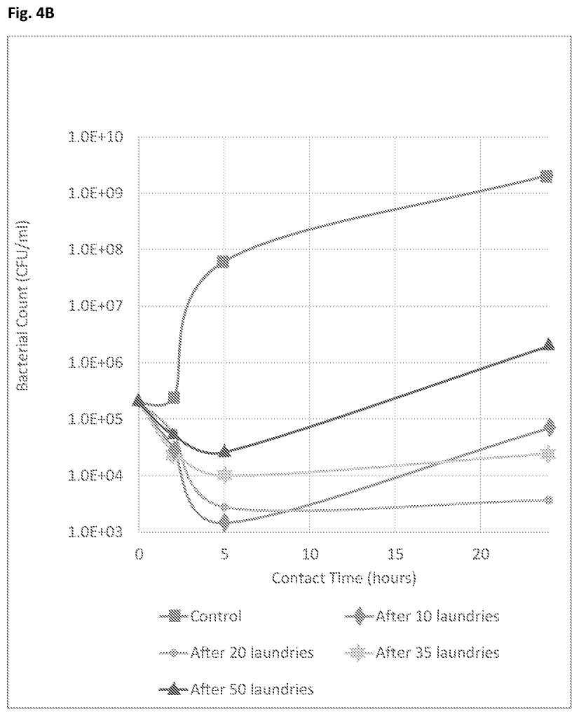

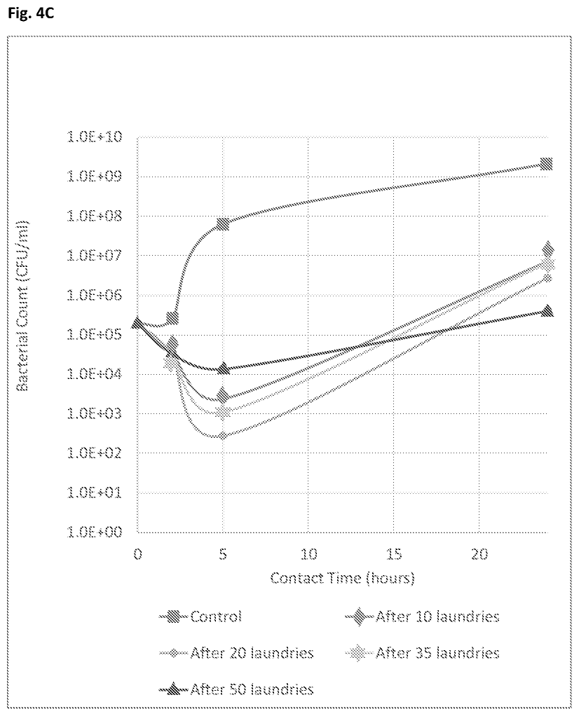

Remarkably, in the presence of the MgO dispersions comprising the various binders types, namely AC-178, AC-2403 and AC-75032 as respectively shown in FIG. 4A, FIG. 4B and FIG. 4C, one to two orders of magnitude reduction in bacterial count were observed after five (5) hours of incubation. This is an evidence for an anti-bacterial effect. From that point and until the experiment end, bacterial count gradually increased, but in any case was at least two orders of magnitude lower than that observed for the control measurement.

Analysis of the bacterial counts obtained for the various dispersions under different laundry conditions of 10, 20, 35 and 50 cycles show that there was a modest effect to the number of washing cycles applied to the coated fabric. For example, when the AC-178 or AC-2403 binders were used, as shown in FIG. 4A and FIG. 4B, respectively, there was an advantage to 10 or 20 laundry cycles and when the AC-75032 binder was used, as shown in FIG. 4C, there was an advantage to 20 laundry cycles.

Remarkably, as shown in FIG. 4C, when analyzing the bacterial counts obtained after an incubation period of 24 hours, the dispersion comprising the AC-75032 binder had an advantage over the other binders used, since the fabric samples performed similarly, regardless of the number of laundry cycles applied to the fabric.

In addition, a clear bacteriostatic and a modest anti-bacterial effect were demonstrated even after subjecting the fabric samples to 50 laundry cycles and under all types of dispersions used, with respect to the control measurement, at all time points. These effects are particularly pronounced after an incubation period of five hours.

Without wishing to be bound by theory, the minor variation in MgO add on percentage out of the fabric total weight did not affect the anti-bacterial or bacteriostatic activity of the MgO dispersion.

Example 5 (Reference Example)

Antimicrobial Activity of Mg(OH)₂-Impregnated Textiles

The use of aqueous dispersions comprising various concentrations of Mg(OH)₂ as an antimicrobial finishing agent for textiles was further examined, as a reference. Two types of textile were used: 50%/50% polyester/cotton 175 g/m² and 100% cotton 200 g/m².

The fabrics were first coated with Mg(OH)₂ dispersions, prepared as described above and diluted (with water) to obtain the required final (add on) percentage for Mg(OH)₂, and cured at 160° C. for 4 minutes. As a result of padding the fabrics with the various dispersions, several fabrics were obtained, differing in their total solids and Mg(OH)₂ percentages. The percentages of the total solids, also referred to herein as “add on” percentage, and of the Mg(OH)₂ deposited on the textile samples are given in Table 16 below, both for 50/50 fabric and for 100% cotton fabric.

TABLE 16
Percentages of total solids and Mg(OH)₂ in coated fabrics

| | % | |
|---|---|---|
| | Total solids | % |
| | (% add-on) | Mg(OH)₂ |
| 50/50 | 6 | 4.8 |
| Polyester/Cotton | 8.4 | 6.7 |
| | 9 | 7.2 |
| | 7.2 | 5.8 |
| | 8.7 | 6.96 |
| | 8.2 | 6.6 |
| | 7.5 | 6.0 |
| | 7.3 | 5.84 |
| | 11.5 | 8.9 |
| | 0 | 0 |
| 100% Cotton | 10 | 7.1 |
| | 7.3 | 5.2 |
| | 6.9 | 4.9 |
| | 6.0 | 4.3 |
| | 8.4 | 6 |
| | 17.9 | 12.8 |
| | 17.9 | 12.8 |
| | 9.1 | 6.6 |
| | 13.3 | 9.5 |
| | 8.9 | 6.4 |
| | 0 | 0 |

Next, the two fabric types were subjected to the AATCC Test Method 100-2019, as described above, by inoculating the fabrics with Staphylococcus aureus (ATCC 6538).

For both fabric types, the percentage of bacterial reduction increased as the amount of Mg(OH)₂ in the fabric increased. In the case of the 50%/50% polyester/cotton fabric, as shown in Table 17 below, the percentage of bacterial reduction increased from 0 at 2.36% Mg(OH)₂ content to 83.4% reduction at 8.9% Mg(OH)₂ content. On the control fabric, an increase in bacterial growth of 0.5 order of magnitude was observed (data not shown).

TABLE 17
Bacterial count reduction (%) for Staphylococcus aureus
on 50/50 woven cotton polyester coated by Mg(OH)₂ dispersions
after an incubation time of 24 hours

| Mg(OH)₂ (% in textile) | Bacterial Reduction (%) |
|---|---|
| 2.36 | 0.0 |
| 4.8-5.1 | 60.7 |
| 5.65-6.75 | 72.4 |
| 7.2 | 77.6 |
| 8.9 | 83.4 |

On the same fabric type, padding with further dispersions comprising Mg(OH)₂ reduced bacterial count as can be seen in Table 18:

TABLE 18
Bacterial count reduction (%) for Staphylococcus aureus
on 50/50 woven cotton polyester coated by Mg(OH)₂ dispersions
after an incubation time of 24 hours

| Mg (OH)₂ (% in textile) | Bacterial Reduction (%) |
|---|---|
| 6.53-7.59 | 60.69 |
| 7.60-8.7 | 81.92 |

In addition, the anti-bacterial activity of 100% cotton knit fabric padded with dispersions comprising Mg(OH)₂ after 5 washing machine cycles, is provided in Table 19:

TABLE 19
% Bacterial count reduction (%) of Staphylococcus aureus
after an incubation time of 24 hours on 100% cotton knits, containing
Mg(OH)₂ after 5 washing machine cycles.

| | Mg (OH)2 % | |
|---|---|---|
| | in textile | Bacterial Reduction |
| Experiment 1 | 7.10-9.55 | 37 |
| Experiment 2 | 7.10-9.55 | 95 |

In additional experiments performed with the 100% cotton fabric, padded with dispersions comprising Mg(OH)₂ after a few washing machine cycles, the results of which are shown in Table 20 below, percentage of bacterial reduction increased from 75.4% at 4.3% Mg(OH)₂ content in textile to 98.9% reduction at 12.8% Mg(OH)₂ content in textile. In contrast, the control fabric sample showed two orders of magnitude increase in the bacterial number.

TABLE 20
Percentage of bacterial count reduction of Staphylococcus aureus
on 100% cotton knits, containing Mg(OH)2 after
an incubation of 24 hours

| Mg(OH)₂ (% in textile) | Bacterial Reduction (%) |
|---|---|
| 4.3 | 75.4 |
| 5.2-6 | 91.6 |
| 6.6-7.1 | 97.0 |
| 12.80 | 98.9 |

### Example 6

Anti-Bacterial Activity of Different Magnesium Oxide Compounds Coatings of 100% Cotton Knits

Next, the anti-bacterial activity of aqueous dispersions comprising magnesium oxide of different grades, coated on 100% cotton knits was examined against Staphylococcus aureus (ATCC 6538). The anti-bacterial activity of fabric coating by aqueous dispersions comprising Mg(OH)₂ was also determined, as reference.

First, different aqueous dispersions of Mg(OH)₂ or MgO (60 g of each) of the grades SIG, E-10A and RA-40 for MgO and of grades S-10, HD-5 and HD-12 for Mg(OH)₂ were prepared generally as described above (Table 6).

These dispersions were padded onto 100% cotton textiles and the fabrics were cured at 160° C. for 4 minutes. The percentages of Mg(OH)₂/MgO deposited on the textile samples were between 5% to 10% as detailed in Table 21 below. The anti-bacterial activity of the tested fabrics was examined without washing the coated and cured fabrics or after 5 washing machine cycles. The results are presented in Table 21 below.

TABLE 21
Percentage of bacterial count reduction and log reduction
of Staphylococcus aureus on 100% cotton knits, containing
Mg(OH)₂ or MgO after an incubation of 24 hours

| | | % kill (log reduction) | | | |
|---|---|---|---|---|---|
| | | | | After 5 | |
| Magnesia | Grade (% add | | | washing | |
| type | on) | No washing | | cycles | |
| MgO | SIG (9.3) | 99.97 | (3.3) | 99.96 | (2.9) |
| MgO | E-10A (7.5) | 99.96 | (2.7) | 99.85 | (2.1) |
| MgO | RA-40 (8.76) | 99.65 | (2.3) | 99.61 | (2.2) |
| Mg(OH)₂ | S-10 (8.44) | 97.36 | (1.6) | 97.69 | (1.6) |
| Mg(OH)₂ | HD-5 (7.06) | 97.64 | (1.0) | 99.36 | (1.6) |
| Mg(OH)₂ | HD-12 (10.5) | 54.62 | (0.31) | 94.9 | (1.46) |

Upon review of Table 21, it is first seen that the anti-bacterial efficacy of all MgO grades was superior comparing to the efficacy of the Mg(OH)₂ grades. Among the three tested MgO grades, an aqueous dispersion comprising MgO SIG grade was found to have the highest efficacy against the tested bacteria.

Furthermore, in most cases washing the fabric after the coating step thereof does not have any significance on the properties of the fabric.

In order to evaluate the effect of the stability of the magnesia dispersion on the bacterial activity, the magnesia dispersion was padded onto fabrics immediately and after it (namely the magnesia dispersion) was aged for one week. No significant differences in the fabrics antimicrobial activity were observed on both treated fabrics (data not shown).

### Example 7

Anti-Bacterial Activity of Commercial Products

As another reference, the test was repeated on commercial antibacterial socks and kitchen Rags (Table 22). Briefly, the antibacterial socks and kitchen Rags detailed in Table 22 below were inoculated with Staphylococcus aureus using the method detailed above for the magnesia coated fabrics. As demonstrated by the results presented in Table 22 below, only the active ingredient Triclosan (in the product names “Ultra-Fresh NM-V2” kitchen rags) had an anti-bacterial activity similar to that of MgO.

TABLE 22
Percentages of bacterial count reduction and log reduction
of Staphylococcus aureus on silver socks, Microban ® rags
and on Triclosan rags after an incubation of 24 hours

| | Active | | % kill | |
|---|---|---|---|---|
| Product name | ingredient | Source | (log reduction) | |
| Antibacterial | silver | URIEL ® | 0 | (0) |
| socks | threads | Foot Care | | |
| | | Item 394 | | |
| Microban ® | Zinc | Microban ® | 97.52 | (1.6) |
| (Kitchen Rags) | Phyrithione | Antibacterial | | |
| | | protection | | |
| Ultra-Fresh ® | Triclosan | Thomson | 99.99 | (4.2) |
| NM-V2 | | Research | | |
| (Kitchen Rags) | | Associates | | |

As an additional reference, the test was repeated on commercial fabrics comprising zinc oxide or copper, which are used, among others, for preparing facial masks. These fabrics were compared to spunbond nonwoven polypropylene 30 GSM padded with a dispersion comprising MgO prepared as described above.

The results of an ATCC test performed in the presence of Coliphage MS2 are shown in Table 23 below. As evident from Table 23 below, spunbond nonwoven polypropylene 30 GSM fabric padded with a dispersion comprising MgO was most effective in decreasing the viral count after 24 hours of incubation when compared to the control or the commercial products zinc-oxide based mask or copper based (nonwoven) mask.

TABLE 23
ATCC test performed with Coliphage MS2 on commercial products
and with Spunbond nonwoven polypropylene 30 GSM

| | Viral count | Viral count |
|---|---|---|
| | (zero time) | (24 hours) |
| Fabric type | PFU/ml | PFU/ml |
| Spunbond nonwoven polypropylene | 2.20E+06 | 1.10E+06 |
| 30 GSM (control) | | |
| Zinc-Oxide based mask | 1.45E+06 | 2.88E+04 |
| Copper based mask nonwoven | 2.10E+06 | 4.83E+03 |
| Spunbond nonwoven polypropylene | 2.40E+06 | 2.50E+02 |
| 30 GSM padded with MgO | | |
| dispersion | | |

### Example 8

Anti-Bacterial Activity of Dispersions Comprising Magnesia of Different Grades Coated on 65% Polyester 35% Cotton Fabrics

Further to the experimental results shown above, textile formulations of various MgO grades (namely HA4, SIG-S and SIG-SC MgO grades, prepared as detailed above) were prepared, specifically using AC-2403 (binder) and HEC (thickener) at 27.2 and 1.44 gr, respectively in preparing the dispersion tabulated at Table 6 above. The dispersions were let to mix for 2 hours.

Then, the above-detailed dispersions comprising HA4, SIG-S or SIG-SC or dispersions comprising HA4, SIG-S or SIG-SC two-fold diluted with water were padded on a 65% polyester, 35% cotton, 200 gr/m² fabric.

The fabrics were tested for antibacterial activity using the ATCC 100-2004 method, as detailed above. Briefly, fabrics were cut into 4.8 cm diameter samples and sterilized by an autoclave sterilization. Next, two (2) samples for each tested fabric were inoculated with Staphylococcus aureus bacteria (2 ml, ATCC 6538). Samples were tested at time zero (0) and after a 24 hour incubation. At these times a neutralization agent (20 ml) was added and the samples were seeded on agar plates and incubated at 37° C. for 48 hours. The results are summarized in Table 24 below.

TABLE 24
Anti-bacterial activity of dispersions comprising
different MgO grades coated on 65% polyester 35%
cotton fabrics, after incubation of 24 hours

| | | | Bacterial | Bacterial |
|---|---|---|---|---|
| | | | Count, | Count, |
| | | | ZERO (0) | 24 hrs |
| Type of MgO | % Add-on | % MgO | time CFU/ml | CFU/ml |
| None | 0 | 0 | 2.10E+06 | 3.28E+09 |
| (control) | | | | |
| HA4 | 9.90 | 7.35 | 1.63E+06 | 8.23E+06 |
| HA4 | 5.00 | 3.71 | 1.93E+06 | 2.90E+06 |
| SIG-S | 12.60 | 9.36 | 1.73E+06 | 2.88E+05 |
| SIG-S | 6.80 | 5.05 | 1.75E+06 | 1.40E+06 |
| SIG-SC | 5.80 | 4.31 | 1.45E+06 | 1.00E+02 |
| SIG-SC | 11.80 | 8.76 | 1.65E+06 | 4.65E+05 |

* % Add-on relates to the weight percentage of solids (MgO, APP or their combination along with all additives, e.g. a binder) included in the dispersion of total fabric weight;
** % MgO relates to the weight percentage of MgO of the total fabric weight.

As shown in Table 24, on fabrics that were not treated by MgO, bacterial count increased by three (3) orders of magnitude.

Fabric samples treated by HA4 grade of MgO (for obtaining percentages of 7.35% and 3.71% in the fabric) and fabric sample treated by SIG-S grade MgO (for obtaining percentage of 5.05% in the fabric) demonstrated that the magnesia had a strong bacteriostatic effect, displaying no change in the bacterial count after 24 hours, compared to time zero.

Fabric samples treated by SIG-S and SIG-SC grades of MgO, respectively (at final percentages of 9.36% and 8.76%, respectively) showed a strong biostatic effect and a moderate anti-bacterial effect, displaying one order of magnitude reduction in the bacterial count after 24 hours, compared to time zero.

Remarkably, the fabric sample treated by SIG-SC grade of MgO (at final percentage of 4.31%) showed a strong anti-bacterial effect, displaying a decrease of four (4) orders of magnitude in the bacterial count after 24 hours, compared to time zero.

### Example 9

Anti-Bacterial Activity of Dispersions Comprising HA4 Grade MgO Coating Single Surfaces of Non-Woven 100% Polypropylene Fabrics

Next, the anti-bacterial effect of dispersions comprising HA4 grade MgO, such that a total add on percentage of 10.0% and 10.4% was obtained was tested. The dispersions were prepared as detailed above (Table 6).

In this example, the dispersions were applied only on one of the fabric surfaces (by back-coating, and the surfaces were termed surface “A” or “B”, namely only on surface A or only on surface B) and the anti-bacterial effect of treated fabrics were compared. Table 25 below show the results of these experiments.

TABLE 25
Bacterial count of Staphylococcus aureus (ATCC 6538) on 100%
polypropylene fabric coated with MgO HA4 grade dispersions.

| | | Bacterial count | Bacterial count |
|---|---|---|---|
| | | (zero time) | (24 hours) |
| % Add on | Treatment | CFU/ml | CFU/ml |
| 0 | Control | 1.05E+07 | 2.98E+09 |
| 10.4 | Surface A | 4.30E+06 | 1.18E+06 |
| 10.0 | Surface A | 3.73E+06 | 2.3E+06 |
| 10.4 | Surface B | 4.38E+06 | 2.38E+06 |
| 10.0 | Surface B | 4.83E+06 | 5.30E+06 |

As shown in Table 25, on the fabric sample that was not treated by magnesia (control), there was a two orders of magnitude increase in the bacterial count was observed.

Fabric samples treated by HA4 grade MgO such that the add on percentage was 10.0% or 10.4% showed that the magnesia had a strong bacteriostatic effect, displaying no change in the bacterial count after 24 hours, compared to time zero.

Furthermore, it can be seen that the bacteriostatic effect obtained when the dispersion was padded on surface A was similar to the bacteriostatic effect obtained when the dispersion was padded on surface B for both types of dispersions tested, implying that the magnesia penetrates through the fabric and reaches both sides.

Similar results were obtained for 100% polypropylene fabric samples coated on one of their surfaces with MgO HA4 grade dispersions prepared as detailed above (namely such that the total add on percentage was of 10.0% or 10.4%), inoculated with E. coli. Table 26 below show the results of these experiments.

TABLE 26
Bacterial count of E. coli on 100% polypropylene
fabric coated with MgO HA4 grade dispersions

| | | Bacterial count | Bacterial count |
|---|---|---|---|
| | | (zero time) | (24 hours) |
| % Add on | Treatment | CFU/ml | CFU/ml |
| 0 | Control | 7.90E+05 | 5.33E+09 |
| 10.4 | Surface A | 7.40E+05 | 1.50E+07 |
| 10.0 | Surface A | 8.90E+05 | 5.70E+06 |
| 10.4 | Surface B | 7.80E+05 | 1.20E+07 |
| 10.0 | Surface B | 6.55E+05 | 1.16E+07 |

As can be seen from Table 26, on the fabric that was not treated by magnesia (control), an increase of four orders of magnitude in bacterial count was observed.

To the contrary, all fabric samples treated by HA4 grade MgO show that the magnesia had a bacteriostatic effect, displaying a relatively small change in the bacterial count after 24 hours, compared to time zero.

Furthermore, it can be seen that the bacteriostatic effect was displayed on both sides of the fabric, regardless on which side the magnesia was applied, thus implying that the magnesia penetrates through the fabric and reaches both sides.

### Example 10

The Effect of Varying the Percentage of MgO in the Fabric on the Anti-Bacterial Activity of Fabrics Coated with HA4 Grade MgO Dispersions

Finally, the anti-bacterial effect of aqueous dispersions comprising HA4 grade MgO coating on non-woven 100% polyester fabric was tested against Staphylococcus aureus while varying the percentage of MgO in the fabric. To this end, the dispersion prepared as detailed in Table 7 above was prepared and diluted.

TABLE 27
Bacterial count for Staphylococcus aureus
(ATCC 6538) on 100% polyester fabric

| | | | | Bacterial count | Bacterial count |
|---|---|---|---|---|---|
| | % Add | | % MgO | (zero time) | (24 hours) |
| Treatment | on | % Mg | (HA4) | CFU/ml | CFU/ml |
| control | 2.17 | 0.00 | 0.00 | 6.9E+06 | 1.0E+09 |
| control | 2.65 | 0.00 | 0.00 | 5.2E+06 | 1.0E+09 |
| MgO HA4 | 7.34 | 3.14 | 5.20 | 6.4E+06 | 8.0E+06 |
| control | 0.00 | 0.00 | 0.00 | 6.2E+06 | 1.0E+09 |
| control | 0.00 | 0.00 | 0.00 | 8.60E+06 | 4.25E+09 |
| MgO HA4 | 7.30 | 3.81 | 6.32 | 9.25E+06 | 2.620E+07 |
| MgO HA4 | 6.80 | 3.55 | 5.89 | 7.80E+06 | 5.00E+06 |
| control | 1.45 | 0.00 | 0.00 | 7.15E+06 | 4.02E+09 |

* % Add-on relates to the weight percentage of solids included in the dispersion of total fabric weight;
** % Mg and % MgO relate to the weight percentage of Mg and MgO, respectively, of the total fabric weight.

As can be seen from Table 27, on fabrics that were not treated by magnesia (namely the control samples) an increase of three (3) orders of magnitude in bacterial count was observed.

In contrast, the fabric samples treated by HA4 grade MgO such that a general add on percentages of 7.34%, 7.30% and 6.80% were obtained, show that the magnesia had a bacteriostatic effect, displaying a relatively small change in the bacterial count after 24 hours, compared to time zero.

Importantly, it is noted that the dispersion applied on the fabric sample the results of which are indicated at the bottom row of Table 27, comprised all of the formulation components, namely a binder, a surfactant, a thickener and water, only without addition of magnesia. The three (3) orders of magnitude increase in bacterial count observed for this fabric samples indicates that magnesia particles are essential to the bacteriostatic or bactericidal activity.

While the invention has been described using some specific examples, many modifications and variations are possible. It is therefore understood that the invention is not intended to be limited in any way, other than by the scope of the appended claims.

1. A composition comprising magnesium oxide, a surfactant and a thickener.

2. The composition according to claim 1, wherein said magnesium oxide is characterized by having a particle size distribution with d₁₀ ranging from 0.5 to 1.5 μm, d₅₀ ranging from 1.5 μm to 6.0 μm and d₉₀ ranging from 5.0 μm to 45.0 μm, wherein said magnesium oxide is further characterized by having:
a) a surface area ranging from 5.0 to 25.0 m²/gr,
b) a Loss On Ignition (LOI) ranging from 0.2% to 8.0%,
c) a bulk density ranging from 0.25 to 0.50 gr/ml, and
d) a citric acid activity (CAA 40) ranging from 25 to 200 seconds.

3. The composition according to claim 1, wherein said magnesium oxide is characterized by having a particle size distribution with d₁₀ ranging from 0.5 to 1.5 μm, by a d₅₀ ranging from 1.5 to 6.0 μm and by a d₉₀ ranging from 5.0 to 45 μm, a surface area ranging from 5.0 to 25.0 m²/gr, LOI ranging from 0.2 to 5.0%, bulk density ranging from 0.30 to 0.50 gr/ml and by citric acid activity (40) ranging from 80 to 200 seconds.

4. The composition according to claim 1, wherein said magnesium oxide is characterized by having a particle size distribution with d₁₀ ranging from 0.8 to 1.5 μm, by a d₅₀ ranging from 2.5 to 6.0 μm and by a d₉₀ ranging from 10.0 to 45 μm, a surface area ranging from 5.0 to 15.0 m²/gr, LOI ranging from 2.0 to 8.0%, bulk density ranging from 0.25 to 0.35 gr/ml and by citric acid activity (40) ranging from 100 to 200 seconds.

5. The composition according to claim 1, wherein said magnesium oxide is characterized by having a particle size distribution with d₁₀ ranging from 1.0 to 1.5 μm, by a d₅₀ ranging from 2.5 to 6.0 μm and by a d₉₀ ranging from 10.0 to 45.0 μm, a surface area ranging from 5.0 to 10.0 m²/gr, LOI ranging from 0.2 to 6.0%, bulk density ranging from 0.3 to 0.5 gr/ml and by citric acid activity (40) ranging from 100 to 200 seconds.

6. (canceled)

7. An anti-viral and/or anti-bacterial textile finishing aqueous dispersion according to claim 1, comprising:
from 67 to 90% by weight of water;
from 2 to 20% by weight of MgO;
from 0.5 to 4% by weight of surfactant; and
from 0.1 to 0.5% by weight of thickener.

8. The textile finishing aqueous dispersion according to claim 7, comprising a binder.

9. The textile finishing aqueous dispersion according to claim 8, comprising from 1.5 to 15% by weight of a binder.

10. The textile finishing aqueous dispersion according to claim claim 7, further comprising ammonium phosphate or ammonium polyphosphate and optionally comprising a binder.

11. The textile finishing aqueous dispersion according to claim 10, wherein said ammonium polyphosphate is aluminum ammonium polyphosphate.

12. The textile finishing aqueous dispersion according to claim 11, comprising:
from 37 to 94% by weight of water;
from 5 to 20% by weight of magnesium oxide;
from 0.5 to 4% by weight of aluminum ammonium polyphosphate;
from 0.5 to 4% by weight of a surfactant; and
from 0.1 to 0.5% by weight of a thickener.

13. The textile finishing aqueous dispersion according to claim 10, comprising from 1.5 to 15% by weight of a binder.

14.-17. (canceled)

18. A method of finishing or treating a textile product with an anti-viral and/or anti-bacterial aqueous dispersion as defined in claim 7, wherein a binder is present in the dispersion.

19. A method according to claim 18, imparting to the textile product virustatic, anti-viral properties, bacteriostatic or anti-bacterial properties.

20. The method according to claim 19, imparting to the textile product virustatic or anti-viral properties against viruses of the family Coronaviridae, or imparting to the textile product bacteriostatic or anti-bacterial properties against a bacteria associated with a nosocomial infection.

21.-22. (canceled)

23. The method according to claim 20, wherein said nosocomial infection is associated with Staphylococcus aureus or Escherichia coli or a combination thereof.

24. The method according to claim 18, wherein said textile product is a medical textile product, a facial mask or a fabric filter.

25.-26. (canceled)

27. A textile product coated with an anti-viral or anti-bacterial finishing comprising magnesium oxide, wherein the amount of MgO is at least 2% by weight of the textile product.

28. A textile product coated with an anti-viral or anti-bacterial finishing comprising magnesium oxide in combination with ammonium phosphate or ammonium polyphosphate, wherein the amount of MgO is at least 2% and the amount of ammonium phosphate or ammonium polyphosphate is at least 0.5% by weight of the textile product.

29. The textile product according to claim 27, wherein said textile product is a medical textile product, a facial mask or a fabric filter.
